(19) United States
(12) Patent Application Publication
(10) Pub. No.: US 2026/0259624 A1
(43) Pub. Date: Sep. 3, 2026

(54) ELECTRONIC DEVICE AND INTERFACE SYSTEM INCLUDING THE SAME

(71) Applicant: Samsung Display Co., Ltd., Yongin-Si (KR)

(72) Inventors: KEUMDONG JUNG, Yongin-si (KR); JANGHUI KIM, Yongin-si (KR)

(21) Appl. No.: 19/397,527

(22) Filed: Nov. 21, 2025

(30) Foreign Application Priority Data
Feb. 28, 2025 (KR) 10-2025-0026740
Apr. 4, 2025 (KR) 10-2025-0044252

(51) Int. Cl. G06F 3/041; G06F 3/044

(52) U.S. Cl. CPC G06F 3/04166; G06F 3/04162; G06F 3/0443; G06F 2203/04114

(57) ABSTRACT

Disclosed is an electronic device, which includes a sensor layer including a plurality of electrodes, a sensor driver that drives the sensor layer and selectively operates in a first mode or a second mode different from the first mode, and a main driver that controls an operation of the sensor driver, and the sensor driver includes a signal generation circuit that outputs first transmission signals for detecting an input in the first mode to the sensor layer and outputs second transmission signals which are for use by an external object to determine a position relative to the sensor layer, and an input detection circuit that receives detection signals corresponding to the first transmission signals from the sensor layer in the first mode and outputs third transmission signals which are for use by the external object to determine the position.

### CROSS-REFERENCE TO RELATED APPLICATIONS

This application claims priority under 35 U.S.C. § 119 to Korean Patent Application Nos. 10-2025-0026740 filed on February 28, 2025, and 10-2025-0044252 filed on April 04, 2025, in the Korean Intellectual Property Office, the disclosures of which are incorporated by reference herein in their entireties.

### BACKGROUND

Embodiments of the present disclosure described herein relate to an electronic device and an interface system including the same.

Multimedia electronic devices such as televisions, mobile phones, tablet computers, navigation systems, game consoles, and the like include a display device for displaying an image. In addition to a general input method such as a button, a keyboard, a mouse, or the like, electronic devices may include a sensor layer capable of providing a touch-based input method that allows a user to enter information or commands easily and intuitively. The sensor layer may sense a touch or a pressure that are incurred by a user.

### SUMMARY

Embodiments of the present disclosure provide an electronic device having high-speed operation and reduced power consumption, and an interface system including the same.

According to an embodiment of the present disclosure, an electronic device includes a sensor layer including a plurality of electrodes, a sensor driver that drives the sensor layer and selectively operates in a first mode or a second mode different from the first mode, and a main driver that controls an operation of the sensor driver, and the sensor driver includes a signal generation circuit that outputs first transmission signals for detecting an input in the first mode to the sensor layer and outputs second transmission signals to the sensor layer in the second mode, the second transmission signals for use by an external object to determine a position relative to the sensor layer, and an input detection circuit that receives detection signals corresponding to the first transmission signals from the sensor layer in the first mode and outputs third transmission signals to the sensor layer in the second mode, the third transmission signals for use by the external object to determine the position.

According to an embodiment, the input detection circuit may include a signal receiver that receives a detection signal of the detection signals from a corresponding electrode among second electrodes and amplifies and outputs the detection signal, an analog-to-digital converter that converts an analog signal input from the signal receiver into a digital signal, and a signal processor that senses the input based on the digital signal.

According to an embodiment, the signal receiver may include an operational amplifier having an inverting input terminal electrically connected to one of the second electrodes and a non-inverting input terminal for receiving a reference signal, a capacitor connected in parallel to the inverting input terminal of the operational amplifier and an output terminal of the operational amplifier, and a reset switch connected in parallel to both ends of the capacitor.

According to an embodiment, in the second mode, a negative feedback path may be activated connecting the non-inverting input terminal of the operational amplifier and the output terminal of the operational amplifier, and in the second mode, one of the third transmission signals may be input to the non-inverting input terminal of the operational amplifier.

According to an embodiment, in the second mode, a connection between an output of the signal receiver and the analog-to-digital converter may be blocked.

According to an embodiment, the plurality of electrodes may include a plurality of first electrodes and a plurality of second electrodes intersecting with the plurality of first electrodes.

According to an embodiment, during a first sub-frame of the second mode, each of the second transmission signals may be applied to a corresponding electrode among the plurality of first electrodes, and each of the third transmission signals may be applied to a corresponding electrode among the plurality of second electrodes.

According to an embodiment, during a first sub-frame of the second mode, each of the second transmission signals may be applied to a corresponding electrode among the plurality of first electrodes, and during a second sub-frame of the second mode, each of the third transmission signals may be applied to a corresponding electrode among the plurality of second electrodes.

According to an embodiment, during a first sub-frame of the second mode, each of the second transmission signals may be applied to a corresponding electrode among the plurality of first electrodes, and each of a first subset of the third transmission signals may be applied to a corresponding electrode among the plurality of second electrodes, and during a second sub-frame of the second mode, each of the second transmission signals may be applied to a corresponding electrode among the plurality of first electrodes, and each of a second subset of the third transmission signals may be applied to a corresponding electrode among the plurality of second electrodes.

According to an embodiment, during a first sub-frame of the second mode, each of a first subset of the second transmission signals may be applied to a corresponding electrode among the plurality of first electrodes, and each of the third transmission signals may be applied to a corresponding electrode among the plurality of second electrodes, and during a second sub-frame of the second mode, each of a second subset of the second transmission signals may be applied to a corresponding electrode among the plurality of first electrodes, and each of the third transmission signals may be applied to the corresponding electrode among the plurality of second electrodes.

According to an embodiment, during a first sub-frame of the second mode, each of a first subset of the second transmission signals may be applied to a corresponding electrode among the plurality of first electrodes, and each of a first subset of the third transmission signals may be applied to a corresponding electrode among the plurality of second electrodes, during a second sub-frame of the second mode, each of a second subset of the second transmission signals may be applied to a corresponding electrode among the plurality of first electrodes, and each of the first subset of the third transmission signals may be applied to the corresponding electrode among the plurality of second electrodes, during a third sub-frame of the second mode, each of the first subset of the second transmission signals may be applied to the corresponding electrode among the plurality of first electrodes, and each of the second subset of the third transmission signals may be applied to a corresponding electrode among the plurality of second electrodes, and during a fourth sub-frame of the second mode, each of a second subset of the second transmission signals may be applied to the corresponding electrode among the plurality of first electrodes, and each of the second subset of the third transmission signals may be applied to the corresponding electrode among the plurality of second electrodes.

According to an embodiment, an area corresponding to the first sub-frame and an area corresponding to the second sub-frame may share a first electrode of the plurality of first electrodes, and an area corresponding to the first sub-frame and the area corresponding to the third sub-frame may share a second electrode of the plurality of first electrodes.

According to an embodiment, a first subset of the second transmission signals and a first subset of the third transmission signals may be alternately applied to the plurality of first electrodes in a second direction, and a second subset of the second transmission signals and a second subset of the third transmission signals may be alternately applied to the plurality of second electrodes in a first direction.

According to an embodiment, a first subset of the second transmission signals and a first subset of the third transmission signals may be alternately applied to the plurality of first electrodes in a second direction based on a first preset ratio, and a second subset of the second transmission signals and a second subset of the third transmission signals may be alternately applied to the plurality of second electrodes in a first direction based on a second preset ratio.

According to an embodiment, during a frame of the second mode, the second transmission signals and the third transmission signals corresponding to a subset of areas of the sensor layer may be applied, and the subset of areas may be determined based on the position of the external object determined in a previous frame.

According to an embodiment, each of the second transmission signals may be applied to two or more corresponding electrodes.

According to an embodiment, each of the third transmission signals may be applied to two or more corresponding electrodes.

According to an embodiment of the present disclosure, an interface system includes a display panel including a display layer which displays an image and a sensor layer which includes a plurality of electrodes, a display driver that drives the display layer, a sensor driver that drives the sensor layer and selectively operates in a first mode or a second mode different from the first mode, a main driver that controls operations of the display driver and the sensor driver, and an object that receives a signal from the sensor layer and outputs an output signal including position information based on the signal to the main driver, and the sensor driver includes a signal generation circuit that outputs a first transmission signal for detecting an input in the first mode to the sensor layer, and an input detection circuit that receives detection signals corresponding to the first transmission signals from the sensor layer in the first mode, and the sensor driver simultaneously or continuously outputs the second transmission signals and the third transmission signals to the sensor layer in the second mode, the second transmission signals and the third transmission signals for use by the object to determine a position relative to the sensor layer.

According to an embodiment, the second transmission signals may be output from the signal generation circuit, and the third transmission signals may be output from the input detection circuit.

According to an embodiment, the plurality of electrodes may include a plurality of first electrodes and a plurality of second electrodes intersecting with the plurality of first electrodes, and during a first sub-frame of the second mode, each of the second transmission signals may be applied to a corresponding electrode among the plurality of first electrodes, and each of the third transmission signals may be applied to a corresponding electrode among the plurality of second electrodes.

### BRIEF DESCRIPTION OF THE FIGURES

The above and other objects and features of the present disclosure will become apparent by describing in detail embodiments thereof with reference to the accompanying drawings.

FIG. 1 is a block diagram of an electronic device, according to an embodiment.

FIG. 2 is a schematic diagram of electronic devices, according to various embodiments.

FIG. 3A is a usage state diagram of an electronic device, according to an embodiment of the present disclosure.

FIG. 3B is a usage state diagram of an electronic device, according to an embodiment of the present disclosure.

FIG. 4 is a schematic cross-sectional view of a display panel, according to an embodiment of the present disclosure.

FIG. 5 is a diagram for describing an operation of an electronic device and an object, according to an embodiment of the present disclosure.

FIG. 6 is a flowchart illustrating an operation of an interface system, according to an embodiment of the present disclosure.

FIG. 7A is a diagram illustrating a block diagram of a sensor layer and a sensor driver, according to an embodiment of the present disclosure.

FIG. 7B is a diagram illustrating an interface system, according to an embodiment of the present disclosure.

FIG. 8 is a diagram illustrating an interface system, according to an embodiment of the present disclosure.

FIG. 9A is a diagram illustrating a digital code, according to an embodiment of the present disclosure.

FIG. 9B is a waveform diagram illustrating a signal according to a digital code illustrated in FIG. 9A.

FIG. 10 is a diagram for describing weighting coefficients determined between first electrodes and an object, according to an embodiment of the present disclosure.

FIG. 11A illustrates voltage waveforms of signals received from an object.

FIG. 11B illustrates a voltage waveform of a superposed signal in which signals are superposed.

FIG. 12 is a block diagram illustrating a signal output by a sensor driver according to a selected mode, according to an embodiment of the present disclosure.

FIG. 13 is a block diagram illustrating a signal generation circuit, according to an embodiment of the present disclosure.

FIG. 14 is a block diagram illustrating an input detection circuit in a first mode, according to an embodiment of the present disclosure.

FIG. 15 is a block diagram illustrating an input detection circuit in a second mode, according to an embodiment of the present disclosure.

FIG. 16 is a diagram illustrating second transmission signals and third transmission signals in one sub-frame, according to an embodiment of the present disclosure.

FIG. 17 is a diagram illustrating an interface system, according to an embodiment of the present disclosure.

FIG. 18A is a diagram illustrating third transmission signals received by a sensor layer in a first sub-frame, according to an embodiment of the present disclosure.

FIG. 18B is a diagram illustrating second transmission signals received by a sensor layer in a second sub-frame, according to an embodiment of the present disclosure.

FIG. 19A is a diagram illustrating second transmission signals and third transmission signals received by a sensor layer in a first sub-frame, according to an embodiment of the present disclosure.

FIG. 19B is a diagram illustrating second transmission signals and third transmission signals received by a sensor layer in a second sub-frame, according to an embodiment of the present disclosure.

FIG. 20A is a diagram illustrating second transmission signals and third transmission signals received by a sensor layer in a first sub-frame, according to an embodiment of the present disclosure.

FIG. 20B is a diagram illustrating second transmission signals and third transmission signals received by a sensor layer in a second sub-frame, according to an embodiment of the present disclosure.

FIG. 21A is a diagram illustrating second transmission signals and third transmission signals received by a sensor layer in a first sub-frame, according to an embodiment of the present disclosure.

FIG. 21B is a diagram illustrating second transmission signals and third transmission signals received by a sensor layer in a second sub-frame, according to an embodiment of the present disclosure.

FIG. 21C is a diagram illustrating second transmission signals and third transmission signals received by a sensor layer in a third sub-frame, according to an embodiment of the present disclosure.

FIG. 21D is a diagram illustrating second transmission signals and third transmission signals received by a sensor layer in a fourth sub-frame, according to an embodiment of the present disclosure.

FIG. 22A is a diagram illustrating second transmission signals and third transmission signals received by a sensor layer in a first sub-frame, according to an embodiment of the present disclosure.

FIG. 22B is a diagram illustrating second transmission signals and third transmission signals received by a sensor layer in a second sub-frame, according to an embodiment of the present disclosure.

FIG. 22C is a diagram illustrating second transmission signals and third transmission signals received by a sensor layer in a third sub-frame, according to an embodiment of the present disclosure.

FIG. 22D is a diagram illustrating second transmission signals and third transmission signals received by a sensor layer in a fourth sub-frame, according to an embodiment of the present disclosure.

FIG. 23 is a diagram illustrating second transmission signals and third transmission signals in one sub-frame, according to an embodiment of the present disclosure.

FIG. 24 is a diagram illustrating second transmission signals and third transmission signals in one sub-frame, according to an embodiment of the present disclosure.

FIG. 25 is a diagram illustrating second transmission signals and third transmission signals in one sub-frame, according to an embodiment of the present disclosure.

FIG. 26 is a diagram illustrating second transmission signals in one sub-frame, according to an embodiment of the present disclosure.

FIG. 27 is a diagram illustrating third transmission signals in one sub-frame, according to an embodiment of the present disclosure.

### DETAILED DESCRIPTION

In the specification, when one component (or area, layer, part, or the like) is referred to as being “on”, “connected to”, or “coupled to” another component, it should be understood that the former may be directly on, connected to, or coupled to the latter, and also may be on, connected to, or coupled to the latter via a third intervening component.

Like reference numerals refer to like components. Also, in drawings, the thickness, ratio, and dimension of components are exaggerated for effectiveness of description of technical contents.

The terms “first”, “second”, etc. are used to describe various components, but the components are not limited by the terms. The terms are used solely for the purpose distinguishing one element, component, region, layer, or portion from another element, component, region, layer, or portion. For example, without departing from the scope of the present disclosure, a first element, a first component, a first region, a first layer, or a first portion may be termed a second element, a second component, a second region, a second layer, or a second portion, and similarly, a second element, a second component, a second region, a second layer, or a second portion may also be termed a first element, a first component, a first region, a first layer, or a first portion. Singular expressions may include plural expressions unless the context clearly dictates otherwise.

Also, the terms “under”, “beneath”, “on”, “above” are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, components, or a combination thereof.

The terms “part” and “unit” mean a software component or a hardware component that performs a specific function. The hardware component may include, for example, a field-programmable gate array (FPGA) or an application-specific integrated circuit (ASIC). The software component may refer to executable code or data used by executable code in an addressable storage medium. Thus, software components may be, for example, object-oriented software components, class components, and working components, and may include processes, functions, properties, procedures, subroutines, program code segments, drivers, firmwares, micro-codes, circuits, data, databases, data structures, tables, arrays or variables.

Unless defined otherwise, all terms (including technical and scientific terms) used herein have the same meaning as commonly understood by one of ordinary skill in the art to which this disclosure belongs. In addition, terms such as terms defined in commonly used dictionaries should be interpreted as having a meaning consistent with the meaning in the context of the related technology, and should not be interpreted as an ideal or excessively formal meaning unless explicitly defined in the present disclosure.

Hereinafter, embodiments of the present disclosure will be described with reference to accompanying drawings.

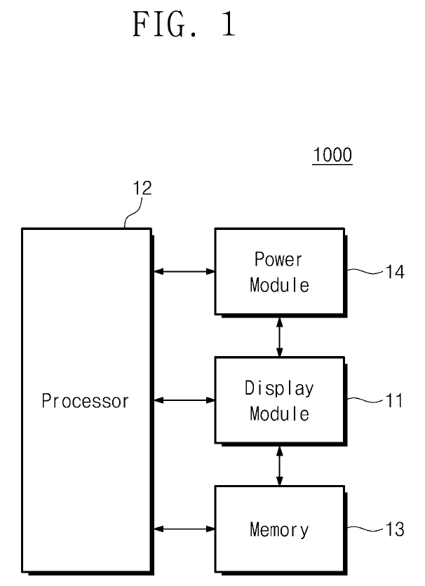

FIG. 1 is a block diagram of an electronic device 1000 according to an embodiment.

Referring to FIG. 1, the electronic device 1000 according to an embodiment may include a display module 11, a processor 12, a memory 13, and a power module 14. The processor may be implemented by more than one processor and two or more processors may be referred to collectively as a processor.

The display module 11 may display an image. The image may include a still image as well as a dynamic image. The processor 12 may include at least one of a central processing unit (CPU), an application processor (AP), a graphics processing unit (GPU), a communication processor (CP), an image signal processor (ISP), and a controller. The processor 12 may be configured to control operations of the display module 11.

The memory 13 may store data information necessary for operations of the processor 12 or the display module 11. When the processor 12 executes an application stored in the memory 13, an image data signal or an input control signal is transferred to the display module 11, and the display module 11 may process the received signal and may output image information through a display screen.

The power module 14 may include a power supply module, such as a power adapter or a battery device, and a power conversion module that converts power supplied by the power supply module to generate power required for the operation of the electronic device 1000.

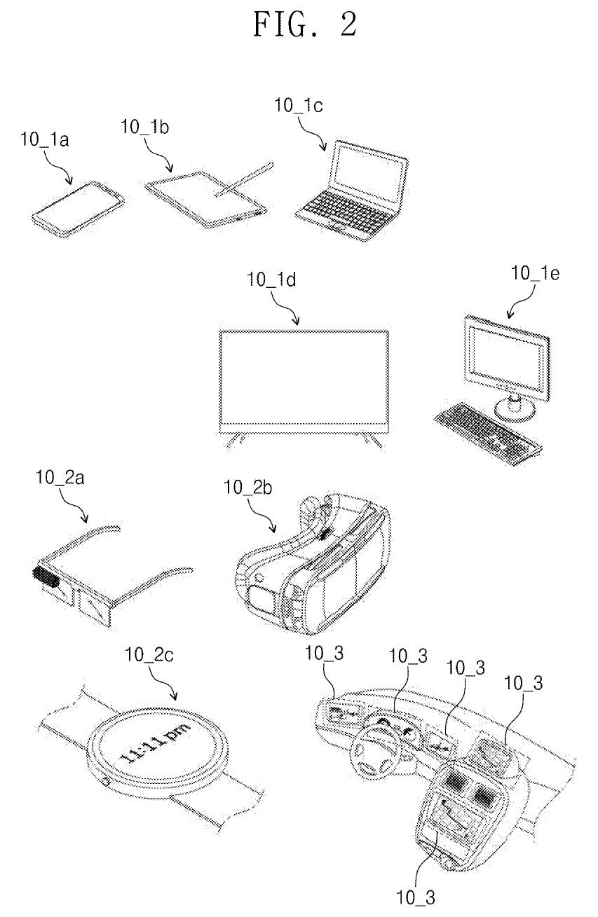

FIG. 2 is a schematic diagram of electronic devices, according to various embodiments.

Referring to FIG. 2, various electronic devices to which display devices according to the embodiments are applied may include not only image display electronic devices such as a smart phone 10_1a, a tablet PC 10_1b, a laptop computer 10_1c, a TV 10_1d, a desk monitor 10_1e, but also wearable electronic devices including display modules such as smart glasses 10_2a, a head-mounted display 10_2b, a smart watch 10_2c, etc., and vehicle electronic devices 10_3 including display modules such as a CID (Center Information Display) placed on an instrument panel, a center fascia, or a dashboard of a vehicle, a room mirror display, etc.

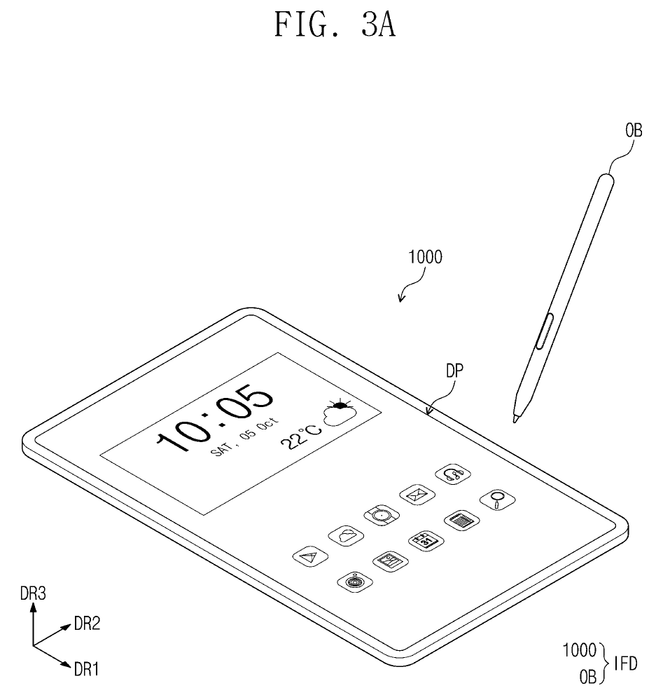

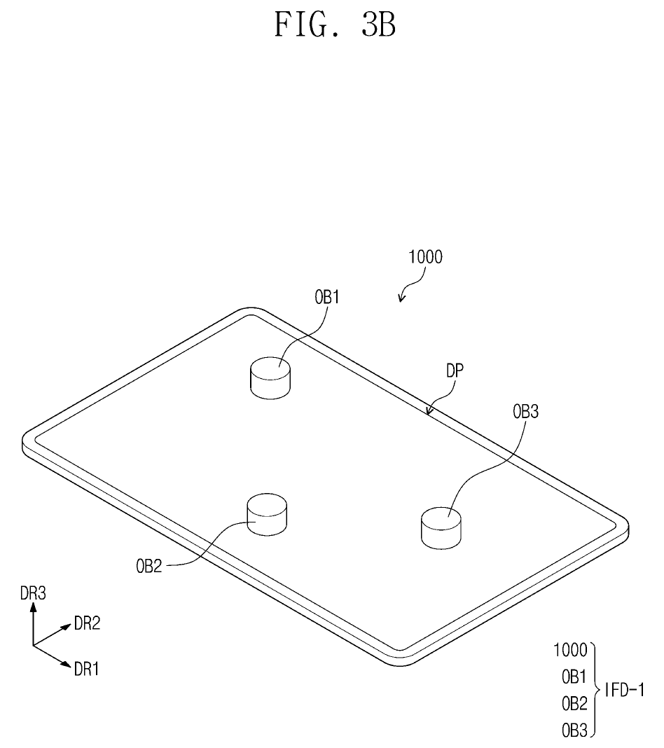

FIG. 3A is a usage state diagram of the electronic device 1000, according to an embodiment of the present disclosure. FIG. 3B is a usage state diagram of the electronic device 1000, according to an embodiment of the present disclosure.

Referring to FIGS. 3A and 3B, the electronic device 1000 may be a device that is activated, in response to an electrical signal. For example, the electronic device 1000 may include a display panel DP. The display panel DP may display an image and may sense inputs applied from the outside. The external input may be a user input. The user input may include various types of external inputs such as a part of a user body, light, heat, or pressure. In addition, the display panel DP may also transmit a signal to objects OB, OB1, OB2, and OB3. The objects OB, OB1, OB2, and OB3 may be referred to as items, transceivers, things, or peripheral devices.

In an embodiment of the present disclosure, the electronic device 1000 may communicate with the objects OB, OB1, OB2, and OB3. Each of the objects OB, OB1, OB2, and OB3 may receive a signal from the electronic device 1000, may decode the signal according to a determined protocol, and restore the position information of each of the objects OB, OB1, OB2, and OB3 within the electronic device 1000. The objects OB, OB1, OB2, and OB3 may transmit the corresponding position information to the electronic device 1000.

Referring to FIG. 3A, the object OB may be a pen. The electronic device 1000 and the object OB interacting (or communicating) with the electronic device 1000 may be referred to as an interface system IFD. The object OB may be referred to as an external object OB. Referring to FIG. 3B, the objects OB1, OB2, and OB3 may be peripheral devices capable of communicating with the electronic device 1000. The electronic device 1000 and the objects OB1, OB2, and OB3 interacting with the electronic device 1000 may be referred to as an interface system IFD-1. The interface system IFD or IFD-1 may be referred to as an interface system, an interface set, an electronic device unit, an electronic device group, or an electronic device set.

In an embodiment of the present disclosure, the objects OB1, OB2, and OB3 may be various items such as a figure, card, toy, or robot capable of communicating, and are not particularly limited thereto. When the objects OB1, OB2, and OB3 are placed on the electronic device 1000, the objects OB1, OB2, and OB3 may transmit position information to each other.

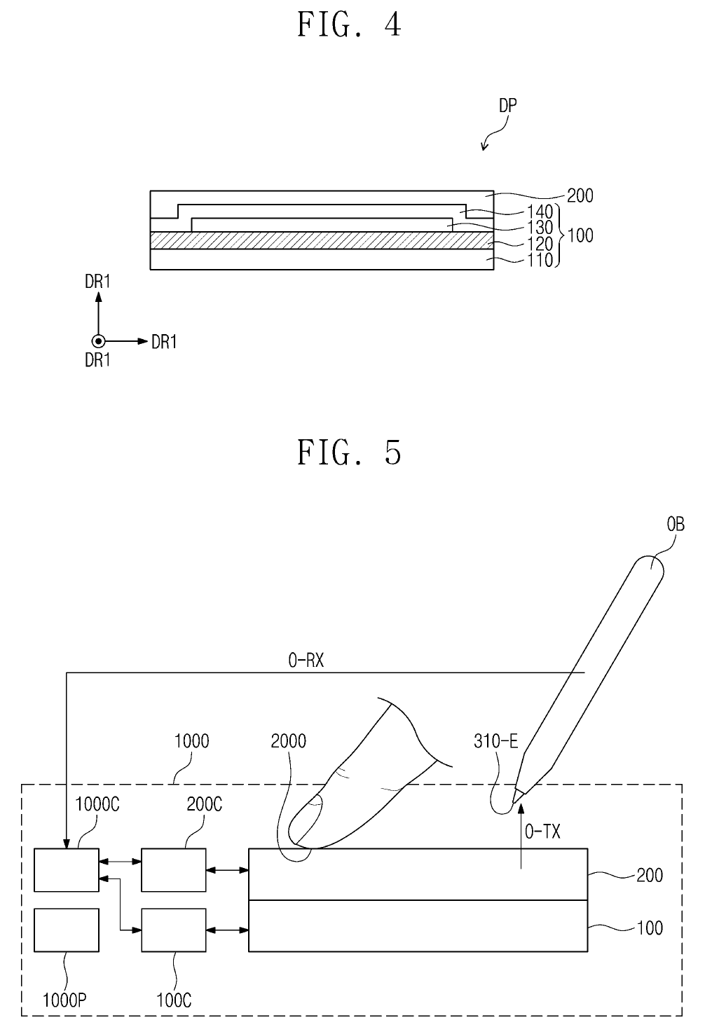

FIG. 4 is a schematic cross-sectional view of the display panel DP, according to an embodiment of the present disclosure.

Referring to FIG. 4, the display panel DP may include a display layer 100 and a sensor layer 200. An upper functional member may be further arranged on top of the sensor layer 200. For example, the upper functional member may include at least one of an anti-reflection layer, a window, and a protective film.

The display layer 100 may be a component which actually generates an image. The display layer 100 may be a light emitting display layer. For example, the display layer 100 may be an organic light emitting display layer, an inorganic light emitting display layer, an organic-inorganic display layer, a quantum dot display layer, a micro-LED display layer, or a nano-LED display layer.

The display layer 100 may include a base layer 110, a circuit layer 120, a light emitting element layer 130, and an encapsulation layer 140.

The base layer 110 may be a member that provides a base surface on which the circuit layer 120 is disposed. The base layer 110 may have a multi-layer structure or a single-layer structure. The base layer 110 may be a glass substrate, a metal substrate, a silicon substrate, or a polymer substrate, but is not particularly limited thereto.

The circuit layer 120 may be disposed on the base layer 110. The circuit layer 120 may include an insulating layer, a semiconductor pattern, a conductive pattern, and a signal line. An insulating layer, a semiconductor layer, and a conductive layer may be formed on the base layer 110 by a method such as coating or deposition, and the insulating layer, the semiconductor layer, and the conductive layer may be selectively patterned through a plurality of photolithography processes.

The light emitting element layer 130 may be disposed on the circuit layer 120. The light emitting element layer 130 may include a light emitting element. For example, the light emitting element layer 130 may include an organic light emitting material, an inorganic light emitting material, an organic-inorganic light emitting material, a quantum dot, a quantum rod, a micro-LED, or a nano-LED.

The encapsulation layer 140 may be disposed on the light emitting element layer 130. The encapsulation layer 140 may protect the light emitting element layer 130 from foreign substances such as moisture, oxygen, and dust particles.

The sensor layer 200 may be disposed on the display layer 100. The sensor layer 200 may sense an external input applied from the outside. The sensor layer 200 may be an integrated sensor continuously formed during the manufacturing process of the display layer 100, or the sensor layer 200 may be an external sensor attached to the display layer 100. The sensor layer 200 may be referred to as a sensor, an input sensing layer, an input sensing panel, or an electronic device for sensing input coordinates.

According to an embodiment of the present disclosure, the sensor layer 200 may sense an input by a passive type input means such as a user’s body. In addition, the sensor layer 200 may also transmit a signal to the objects OB, OB1, OB2, and OB3 described in FIGS. 3A and 3B. This will be more fully detailed later.

FIG. 5 is a diagram for describing an operation of the electronic device 1000 and the object OB, according to an embodiment of the present disclosure.

Referring to FIG. 5, the electronic device 1000 may include the display layer 100, the sensor layer 200, a display driver 100C, a sensor driver 200C, a main driver 1000C, and a power supply circuit 1000P.

The main driver 1000C may control the overall operation of the electronic device 1000. For example, the main driver 1000C may control operations of the display driver 100C and the sensor driver 200C. In detail, the main driver 1000C may control an operation of the display layer 100 and the sensor layer 200. The main driver 1000C may include at least one microprocessor, and may further include a graphics controller. The main driver 1000C may be referred to as a host, an application processor, a central processing unit, or a main processor. The main driver 1000C may correspond to the processor 12 described with reference to FIG. 1.

The display driver 100C may drive the display layer 100. The display driver 100C may receive image data and a control signal from the main driver 1000C. The control signal may include various signals. For example, the control signal may include an input vertical synchronization signal, an input horizontal synchronization signal, a main clock signal, and a data enable signal.

The sensor driver 200C may drive the sensor layer 200. The sensor driver 200C may receive a control signal from the main driver 1000C. The control signal may include a clock signal of the sensor driver 200C. In addition, the control signal may further include a mode determination signal that determines the driving mode of the sensor driver 200C and the sensor layer 200.

The sensor layer 200 may detect an input 2000 applied from the outside or may transmit a signal O-TX to the object OB. For example, the sensor driver 200C and the sensor layer 200 may selectively operate in a first mode or a second mode. For example, the first mode may be a mode for sensing a touch input, for example, the input 2000. The second mode may be a mode for transmitting the signal O-TX to the object OB.

In the first mode, the sensor driver 200C may calculate coordinate information of the input based on a signal received from the sensor layer 200 and may provide a coordinate signal having the coordinate information to the main driver 1000C. The main driver 1000C executes an operation corresponding to user input based on the coordinate signal. For example, the main driver 1000C may operate the display driver 100C such that a new application image is displayed on the display layer 100.

In the second mode, the sensor driver 200C and the sensor layer 200 may only transmit the signal O-TX, and the sensor driver 200C and the sensor layer 200 may not receive an output signal O-RX provided from the object OB and, instead, the output signal O-RX may be provided directly to the main driver 1000C. The output signal O-RX may include position information of the object OB generated based on the signal O-TX. For example, the output signal O-RX may include information about the position of a sensing electrode 310-E of the object OB within the sensor layer 200.

The output signal O-RX provided from the object OB may be output to the main driver 1000C. For example, the output signal O-RX may be provided to the main driver 1000C through short-range communication, such as Bluetooth communication or Wi-Fi communication.

That is, the output signal O-RX output from the object OB is provided directly to the main driver 1000C without passing through the sensor layer 200. Therefore, the output signal O-RX is not affected by noise caused to the sensor layer 200 by the display layer 100. In addition, since the output signal O-RX is provided directly to the main driver 1000C, the speed may be improved compared to the case where the output signal O-RX is transmitted to the main driver 1000C through the sensor layer 200.

The power supply circuit 1000P may include a power management integrated circuit (PMIC). The power supply circuit 1000P may generate a plurality of driving voltages for driving the display layer 100, the sensor layer 200, the display driver 100C, and the sensor driver 200C. For example, the plurality of driving voltages may include a gate high voltage, a gate low voltage, a first driving voltage, a second driving voltage, an initialization voltage, etc., but are not particularly limited to the above examples.

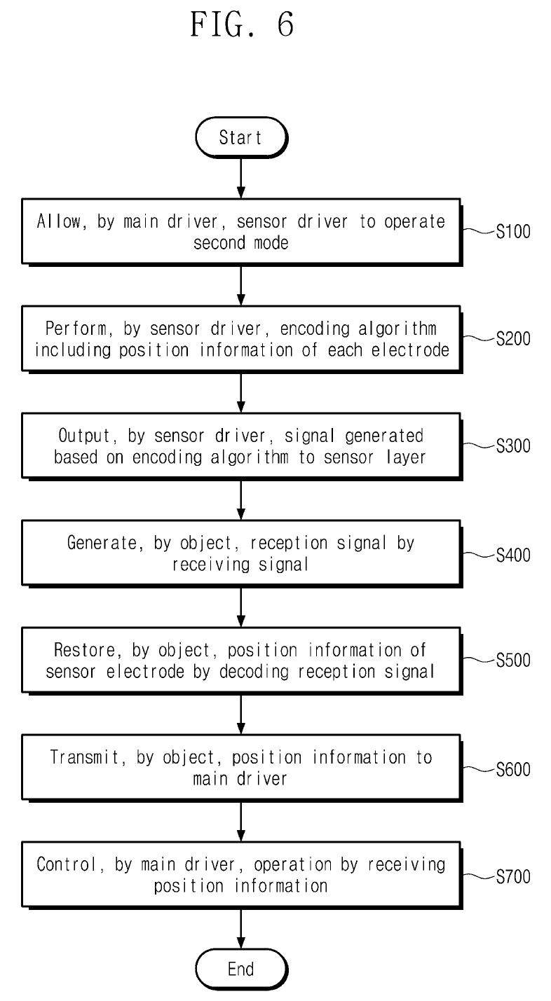

FIG. 6 is a flowchart illustrating the operation of the interface system IFD (refer to FIG. 3A), according to an embodiment of the present disclosure.

Referring to FIGS. 5 and 6, the main driver 1000C may allow the sensor driver 200C to operate in a second mode (S100).

The sensor driver 200C may perform an encoding algorithm including position information of each electrode (S200). The sensor driver 200C may output the signal O-TX generated based on the encoding algorithm to the sensor layer 200 (S300).

The object OB may receive the signal O-TX and may generate a reception signal (S400). The object OB may decode the reception signal and may restore the position information of the sensor electrode in the sensor layer 200 (S500). The object OB may transmit the output signal O-RX including the position information to the main driver 1000C (S600). The main driver 1000C may receive the output signal O-RX including the position information and may control the operation of the display driver 100C or the sensor driver 200C (S700).

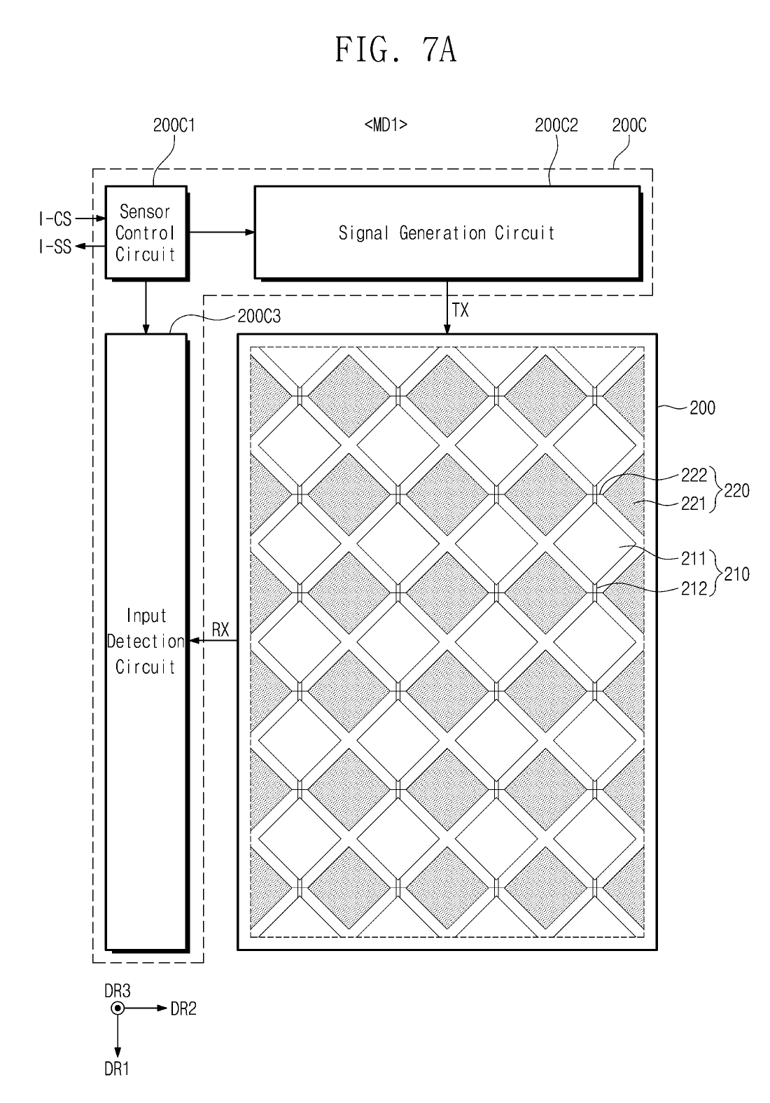

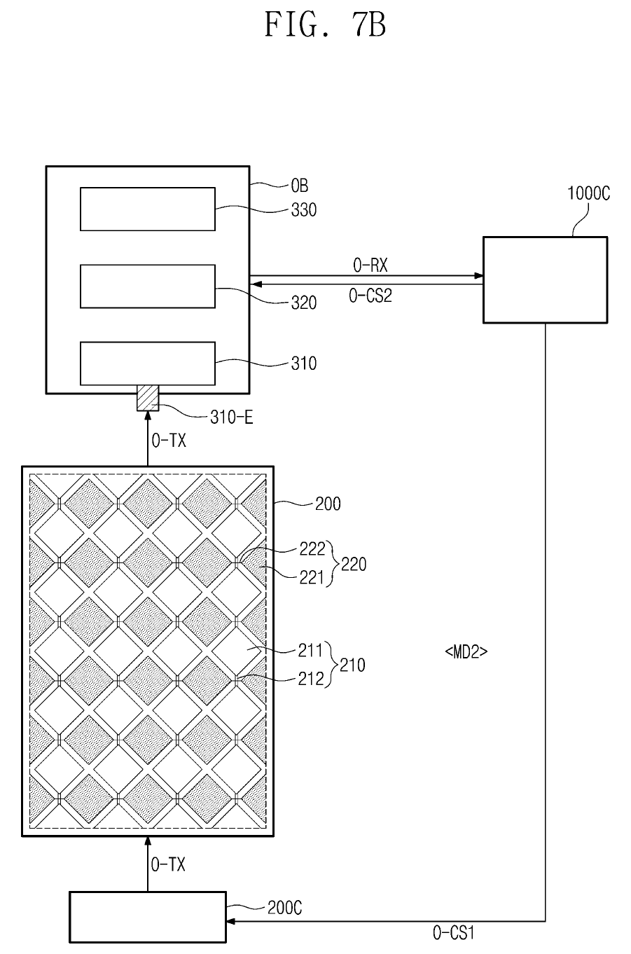

FIG. 7A is a block diagram illustrating the sensor layer 200 and the sensor driver 200C, according to an embodiment of the present disclosure.

Referring to FIG. 7A, the sensor layer 200 may include a plurality of first electrodes 210 and a plurality of second electrodes 220. Each of the first electrodes 210 may extend in a first direction DR1, and the first electrodes 210 may be arranged spaced apart from each other in a second direction DR2. Each of the second electrodes 220 may extend in the second direction DR2, and the second electrodes 220 may be arranged spaced apart from each other in the first direction DR1. Each of the second electrodes 220 may intersect with the first electrodes 210. In FIG. 7A, four first electrodes 210 and six second electrodes 220 are illustrated as examples, but this is only an illustration of a partial configuration, and the sensor layer 200 may include a greater number of first and second electrodes 210 and 220 than the illustrated first electrodes 210 and the illustrated second electrodes 220.

Each of the first electrodes 210 may include a detection pattern 211 and a connection pattern 212. Two adjacent detection patterns 211 may be electrically connected to each other by two connection patterns 212, but are not particularly limited thereto. The detection pattern 211 and the connection patterns 212 may be arranged on different layers.

Each of the second electrodes 220 may include a first portion 221 and a second portion 222. The first portion 221 and the second portion 222 may have an integral shape together with each other and may be disposed on the same layer. For example, the first portion 221 and the second portion 222 may be arranged on the same layer as the detection pattern 211. The two connection patterns 212 may be insulated and crossed with the second portion 222.

The sensor driver 200C may be implemented by one or more integrated circuits (ICs) and is directly mounted on a predetermined area of the sensor layer 200 or on a separate printed circuit board in a chip-on-film (COF) manner to be electrically connected to the sensor layer 200.

The sensor driver 200C may include a sensor control circuit 200C1, a signal generation circuit 200C2, and an input detection circuit 200C3. The sensor control circuit 200C1 may control operations of the signal generation circuit 200C2 and the input detection circuit 200C3 based on a control signal I-CS.

The sensor driver 200C may receive the control signal I-CS from the main driver 1000C (refer to FIG. 5).

In a first mode MD1, the signal generation circuit 200C2 may output transmission signals TX to the first electrodes 210 of the sensor layer 200. The input detection circuit 200C3 may receive detection signals RX from the sensor layer 200. For example, the input detection circuit 200C3 may receive the detection signals RX from the second electrodes 220. In an embodiment of the present disclosure, the signal generation circuit 200C2 may output the transmission signals TX to the second electrodes 220 of the sensor layer 200, and the input detection circuit 200C3 may receive the detection signals RX from the first electrodes 210.

The input detection circuit 200C3 may convert an analog signal into a digital signal. For example, the input detection circuit 200C3 amplifies and then filters the received analog signal. In detail, the input detection circuit 200C3 may convert the filtered signal into a digital signal. The sensor driver 200C may provide a coordinate signal I-SS to the main driver 1000C.

FIG. 7B is a diagram illustrating the interface system IFD (refer to FIG. 3A), according to an embodiment of the present disclosure.

Referring to FIG. 6 and FIG. 7B, the main driver 1000C may allow the sensor driver 200C to operate in a second mode MD2. For example, the main driver 1000C may transmit a first control signal O-CS1 to the sensor driver 200C and may transmit a second control signal O-CS2 to the object OB. For example, the first control signal O-CS1 and the second control signal O-CS2 may include determined (or predetermined) protocol information. The first control signal O-CS1 may include an encoding algorithm (or encoding information), and the second control signal O-CS2 may include a decoding algorithm (or decoding information).

The sensor driver 200C may perform an encoding algorithm including position information of the first electrodes 210 and the second electrodes 220 based on the first control signal O-CS1. Afterwards, the sensor driver 200C may output the signal O-TX generated based on the encoding algorithm to the sensor layer 200. For example, a first digital code in the time domain may be generated based on the encoding algorithm, and the first digital code may be modulated to generate the signal O-TX. That is, the signal O-TX may be an analog signal.

The object OB may include a receiver 310, a decoder 320, and a communication unit 330.

The receiver 310 may include the sensing electrode 310-E, an amplifier, and an analog-to-digital converter. A capacitor is formed between the sensing electrode 310-E and the first electrodes 210 and the second electrodes 220 of the sensor layer 200, and the object OB may receive the signal O-TX through the sensing electrode 310-E. The receiver 310 may convert the signal O-TX into a second digital code in the time domain through the amplifier and the analog-to-digital converter.

The decoder 320 may decode the second digital code to restore the position information of the electrode in the sensor layer 200. The communication unit 330 may transmit the output signal O-RX including the position information to the main driver 1000C.

According to an embodiment of the present disclosure, a driving method for reducing the number of the first digital codes and the number of the second digital codes is described below. According to the driving method, the accuracy of the position information of the object OB in the sensor layer 200 is not reduced, and the time required to drive all channels simultaneously may be reduced. Therefore, even though the size of the electronic device 1000 increases, a high-speed drivable interface system IFD may be provided. The all channels may include the first electrodes 210 and the second electrodes 220.

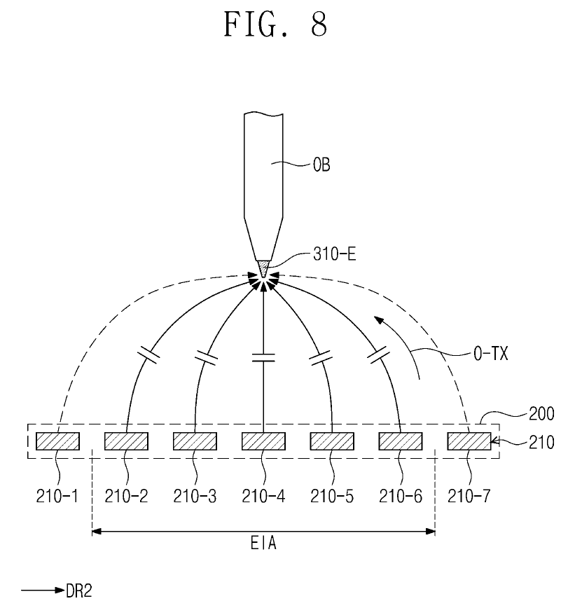

FIG. 8 is a diagram illustrating the interface system IFD (refer to FIG. 3A), according to an embodiment of the present disclosure.

Referring to FIGS. 7B and 8, seven first electrodes 210 included in the sensor layer 200 and the object OB are illustrated as an example. The object OB may receive the signal O-TX from the first electrodes 210.

The intensity of the signal received from first electrodes 210-1 and 210-7 positioned outside an effective impedance area EIA may be very small compared to the intensity of the signal received from five first electrodes 210-2, 210-3, 210-4, 210-5, and 210-6 positioned within the effective impedance area EIA with respect to the object OB. In FIG. 8, it is illustrated as an example that five first electrodes 210-2, 210-3, 210-4, 210-5,and 210-6 are included within the effective impedance area EIA, but it is not particularly limited thereto.

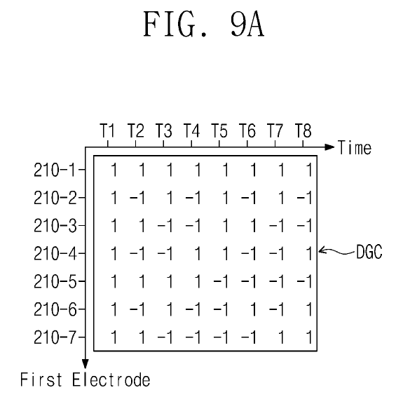

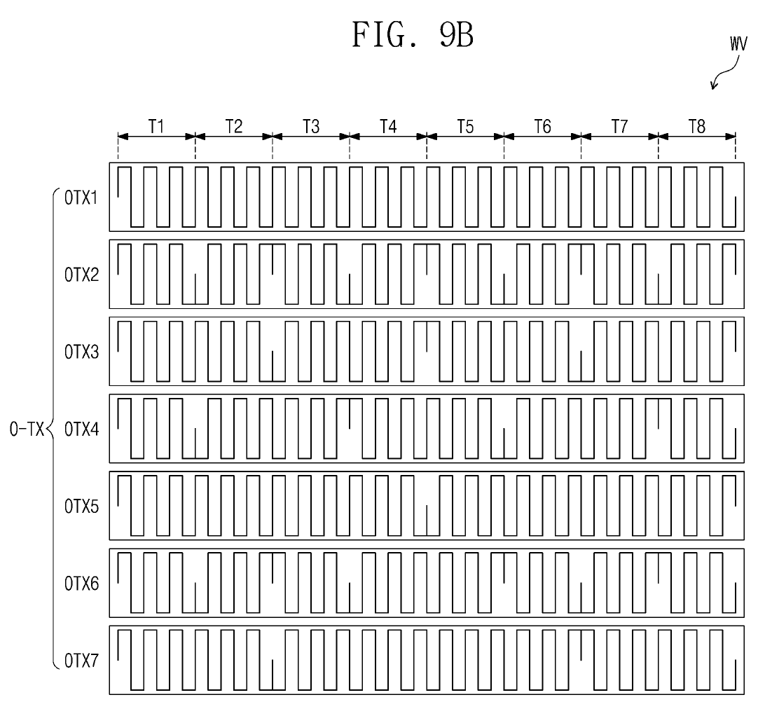

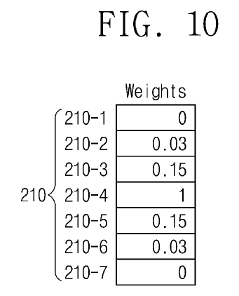

FIG. 9A is a diagram illustrating a digital code DGC, according to an embodiment of the present disclosure. FIG. 9B is a waveform diagram illustrating the signal O-TX according to the digital code DGC illustrated in FIG. 9A.

Referring to FIG. 8 and FIG. 9A, the digital code DGC in the time domain is illustrated. A horizontal axis represents time, and a vertical axis may correspond to the first electrodes 210-1, 210-2, 210-3, 210-4, 210-5, 210-6, and 210-7 arranged in the second direction DR2. The digital code DGC may be a Hadamard code, but is not particularly limited thereto. For example, the digital code DGC may be transformed into various codes when it is an orthogonal code.

FIG. 9B illustrates voltage waveforms WV of signals OTX1, OTX2, OTX3, OTX4, OTX5, OTX6, and OTX7 provided to the first electrodes 210-1, 210-2, 210-3, 210-4, 210-5, 210-6, and 210-7, corresponding to first to eighth time intervals T1, T2, T3, T4, T5, T6, T7, and T8.

The example illustrates that “1” of the digital code DGC is binary phase modulated with a phase of 0 degrees and “-1” of the digital code DGC is binary phase modulated with a phase of 180 degrees, but this is only an example and is not particularly limited thereto. For example, the digital code DGC may be converted using various modulation techniques such as phase modulation, frequency modulation, or amplitude modulation, or may be modulated with a combination of two or more modulation techniques.

FIG. 10 is a diagram illustrating weighting coefficients determined between the first electrodes 210 and the object OB (refer to FIG. 8), according to an embodiment of the present disclosure.

Referring to FIGS. 8 and 10, the weighting coefficients may be changed by impedances between the first electrodes 210 and the sensing electrode 310-E of the object OB. The weighting coefficient of the fourth first electrode 210-4 facing the sensing electrode 310-E of the object OB may be the largest, and the weighting coefficients of the first first electrode 210-1 and the seventh first electrode 210-7, which are located outside the effective impedance area EIA, may be “0”.

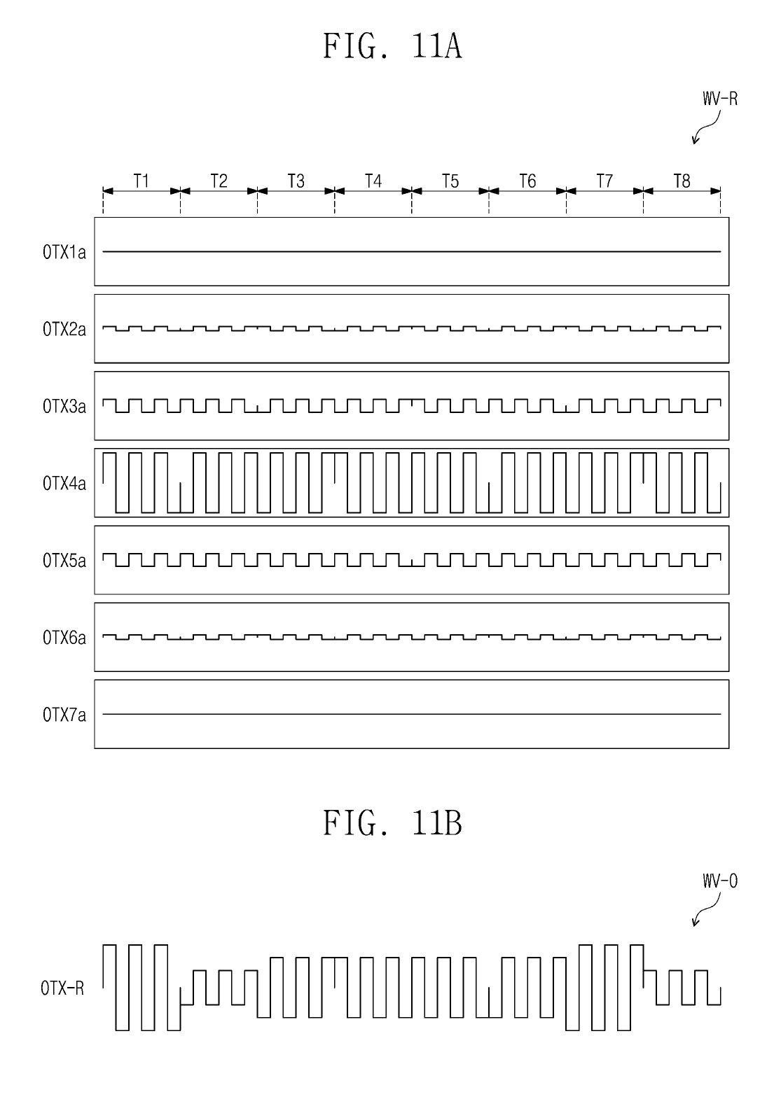

FIG. 11A illustrates voltage waveforms WV-R of signals OTX1a, OTX2a, OTX3a, OTX4a, OTX5a, OTX6a, and OTX7a received from the object OB (refer to FIG. 8). FIG. 11B illustrates voltage waveform WV-O of superposed signals OTX-R in which the signals OTX1a, OTX2a, OTX3a, OTX4a, OTX5a, OTX6a, OTX7a) are superposed.

Referring to FIGS. 9B, 10, 11A, and 11B, the voltage waveforms WV transmitted in the form of FIG. 9B from the sensor layer 200 may be received by the object OB as the voltage waveforms WV-R whose amplitude (or intensity) is adjusted by reflecting the weights of FIG. 10 as in FIG. 11A. That is, the object OB may receive the voltage waveform WV-O in which all of the voltage waveforms WV-R illustrated in FIG. 11A are superposed. The object OB may detect the position information of the object OB within the sensor layer 200 by decoding the voltage waveform WV-O.

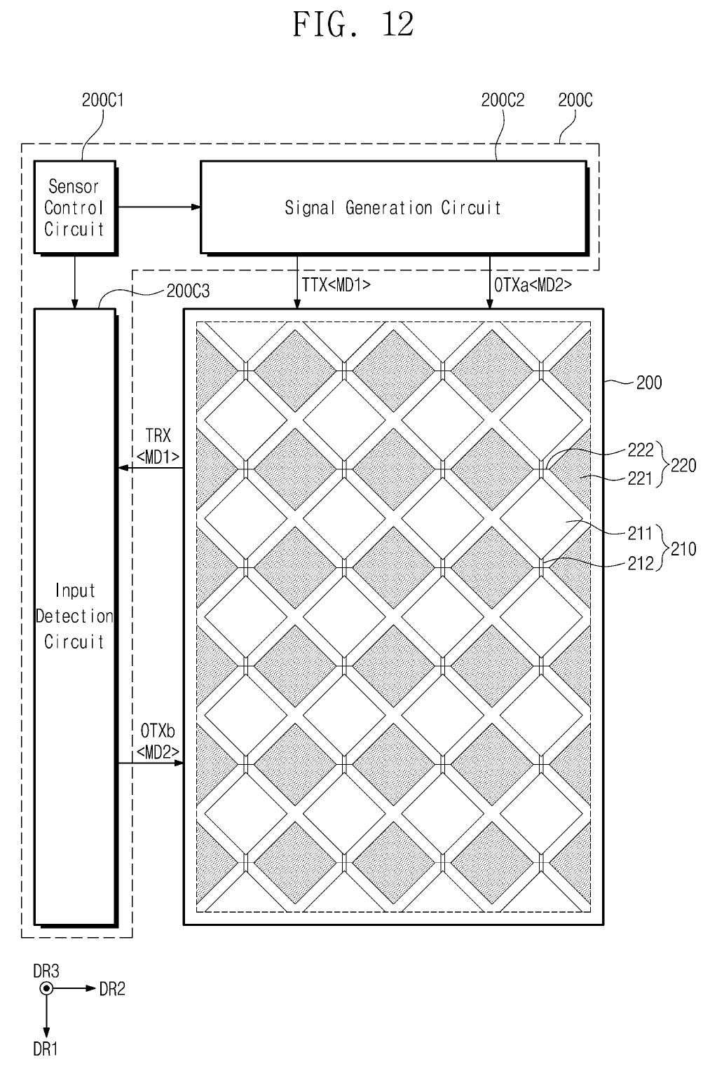

FIG. 12 is a block diagram illustrating a signal output by a sensor driver according to a selected mode, according to an embodiment of the present disclosure.

Referring to FIG. 12, the sensor driver 200C may be configured to selectively operate in the first mode MD1 or the second mode MD2 different from the first mode MD1.

The sensor driver 200C may include the signal generation circuit 200C2 and the input detection circuit 200C3. The signal generation circuit 200C2 may output first transmission signals TTX for sensing input (e.g., touch input) in the first mode MD1 to the sensor layer 200. The signal generation circuit 200C2 may output second transmission signals OTXa that are used by an external object to detect a position of the external objects in the second mode MD2, to the sensor layer 200.

The input detection circuit 200C3 may receive detection signals TRX corresponding to the first transmission signals TTX from the sensor layer 200 in the first mode MD1. The input detection circuit 200C3 may output third transmission signals OTXb that are used by the external object to detects the position in the second mode MD2, to the sensor layer 200.

The first transmission signals TTX output in the first mode MD1 may correspond to the transmission signals TX of FIG. 7A. The detection signals TRX received in the first mode MD1 may correspond to the detection signals RX of FIG. 7A.

The second transmission signals OTXa and the third transmission signals OTXb output in the second mode MD2 are signals used by an object to detect a position of the object relative to the sensor layer 200. The second transmission signals OTXa and the third transmission signals OTXb may be generated through an encoding algorithm that includes position information on the sensor layer 200.

The signals included in the second transmission signals OTXa and the third transmission signals OTXb are applied to the electrodes 210 and 220 included in the sensor layer 200. For example, some or all of the second transmission signals OTXa may be provided to some or all of the first electrodes 210 that are spaced apart in the second direction DR2 and extend in the first direction DR1. Some or all of the third transmission signals OTXb may be provided to some or all of the second electrodes 220 that are spaced apart in the first direction DR1 and extend in the second direction DR2. Alternatively, some or all of the second transmission signals OTXa may be provided as some or all of the channels of the second electrodes 220 and some or all of the third transmission signals OTXb may be provided as some or all of the channels of the first electrodes 210.

Some and other portions of the signals included in the second transmission signals OTXa and the third transmission signals OTXb may be provided in orthogonal directions during the same sub-frame. For example, some or all of the second transmission signals OTXa may be provided in the first direction DR1, and some or all of the third transmission signals OTXb may be provided in the second direction DR2. As another example, some of the second transmission signals OTXa may be provided in the first direction DR1, and some of the remaining may be provided in the second direction DR2. Some of the third transmission signals OTXb may be provided in the second direction DR2, and some of the remaining may be provided in the first direction DR1.

The second transmission signals OTXa and the third transmission signals OTXb may be analog signals generated through an encoding algorithm. The object may receive reception signals corresponding to the second transmission signals OTXa and the third transmission signals OTXb to detect a position, and may decode the reception signals to restore position information. In this case, the position of the object may be determined in one sub-frame through signals provided in orthogonal directions (for example, the first direction DR1 and the second direction DR2) among the second transmission signals OTXa and the third transmission signals OTXb in one sub-frame.

The second transmission signals OTXa and the third transmission signals OTXb may be applied to the electrodes included in the sensor layer 200 through a configuration matrix. The configuration matrix includes a preset connection path and is referred to as a switch matrix or a mux/demux. The configuration matrix may change the signal path between the input/output terminal of the sensor driver 200C and a plurality of electrodes included in the sensor layer 200 depending on the sensing mode or signal application method.

The sensor driver 200C according to the embodiment of the present disclosure may generate signals provided in an orthogonal direction during one sub-frame by including the input detection circuit 200C3 that outputs the third transmission signals OTXb in the second mode MD2. The object may restore position information during a single sub-frame based on the signals provided in an orthogonal direction. Through this, the time required for the object to restore the position information may be reduced relatively.

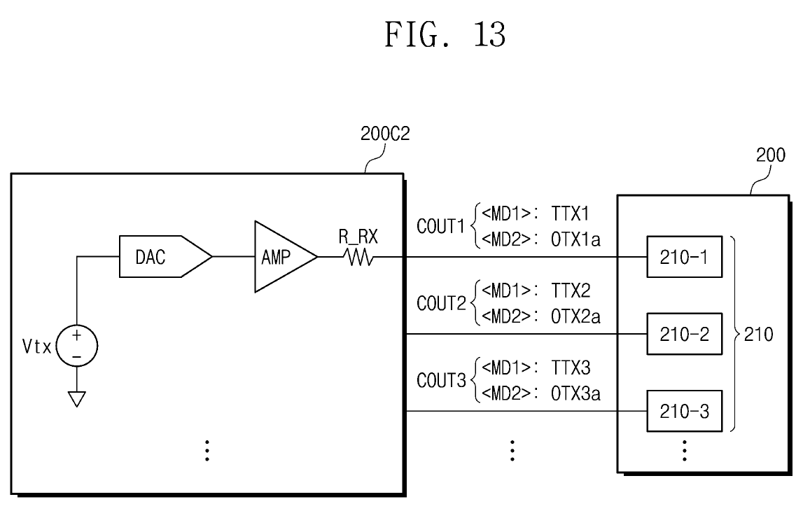

FIG. 13 is a block diagram illustrating a signal generation circuit, according to an embodiment of the present disclosure.

Referring to FIG. 13, the signal generation circuit 200C2 may output output signals COUT1, COUT2, COUT3, ... corresponding to each of the plurality of first electrodes 210-1, 210-2, 210-3, ... .

The output signal COUT1 corresponds to the first electrode 210-1. The signal generation circuit 200C2 may output first transmission signal TTX1 to the first electrode 210-1 in the first mode MD1, and may output the second transmission signal OTX1a to the first electrode 210-1 in the second mode MD2. The signal generation circuit 200C2 may output first transmission signal TTX2 to the first electrode 210-2 in the first mode MD1, and may output the second transmission signal OTX2a to the first electrode 210-2 in the second mode MD2. The signal generation circuit 200C2 may output first transmission signal TTX3 to the first electrode 210-3 in the first mode MD1, and may output the second transmission signal OTX3a to the first electrode 210-3 in the second mode MD2. The first transmission signals TTX1, TTX2, TTX3, ... are driving signals applied to the first electrodes 210 to sense an input. The second transmission signals OTX1a, OTX2a, OTX3a, ... are signals used to determine the object position.

The signal generation circuit 200C2 may include a signal source Vtx, a digital-to-analog converter DAC, an amplifier AMP, and a transmission resistor R_TX, corresponding to the output signal COUT1.

The signal source Vtx and the digital-to-analog converter DAC may generate a signal for driving the first electrode 210-1 included in the sensor layer 200 based on a control signal received from the sensor control circuit 200C1. The amplifier AMP may amplify the received signal. The amplified signal corresponds to the first transmission signal TTX1 and is transmitted to the first electrode 210-1. The signal generation circuit 200C2 may further include a plurality of signal sources Vtx, a plurality of digital-to-analog converters DACs, a plurality of amplifiers AMPs, and a plurality of transmission resistors R_TX, corresponding to the output signals COUT2, COUT3, ..., respectively. The plurality of signal sources Vtx and the plurality of digital-to-analog converters DACs may output the second transmission signals OTX1a, OTX2a, OTX3a, ... according to the encoding result in the second mode MD2.

The signal generation circuit 200C2 may output signals to the second electrodes 220 as well as the first electrodes 210. The signal generation circuit 200C2 and the electrodes 210 and 220 included in the sensor layer 200 may be connected to a preset path through a configuration matrix. The signal generation circuit 200C2 may output the first transmission signals TTX1, TTX2, TTX3, ... to the first electrodes 210 in the first mode MD1. The signal generation circuit 200C2 may output the second transmission signals OTX1a, OTX2a, OTX3a, ... to some or all of the first electrodes 210-1, 210-2, 210-3, ... in the second mode MD2, or to some or all of the second electrodes 220 in the second mode MD2.

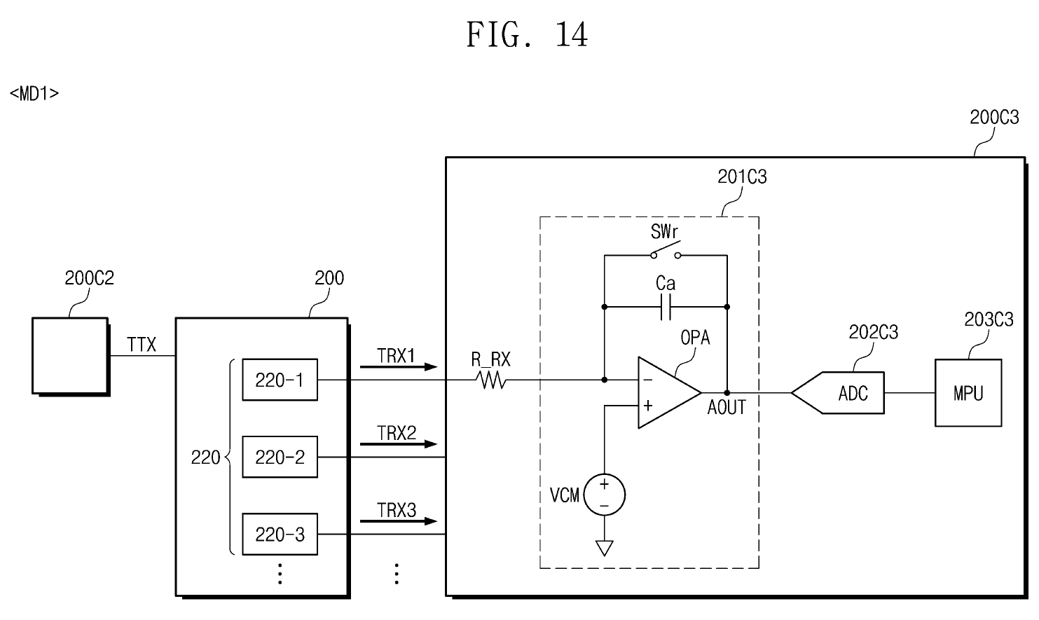

FIG. 14 is a block diagram illustrating an input detection circuit in a first mode, according to an embodiment of the present disclosure.

Referring to FIG. 14, the input detection circuit 200C3 may receive a plurality of detection signals TRX1, TRX2, TRX3, ... in the first mode MD1.

The signal generation circuit 200C2 may output the first transmission signals TTX to the sensor layer 200 in the first mode MD1. A capacitance may be formed between the first electrodes (not illustrated) and the second electrodes 220-1, 220-2, 220-3, ..., which are included in the sensor layer 200. In response to the first transmission signals TTX applied to the first electrodes, the detection signals TRX1, TRX2, TRX3, ... may be generated from the second electrodes 220-1, 220-2, 220-3, ... . The input detection circuit 200C3 may receive the detection signals TRX1, TRX2, TRX3, ... corresponding to each of the second electrodes 220-1, 220-2, 220-3, ... . Based on the detection signals TRX1, TRX2, TRX3, ..., the presence or absence of an input or the position of an input may be determined.

The input detection circuit 200C3 may include a plurality of reception resistors R_RX, a plurality of signal receivers 201C3, at least one analog-to-digital converter 202C3, and at least one signal processor 203C3.

The signal receiver 201C3 may receive the detection signal TRX1 from the corresponding second electrode 220-1. The signal receiver 201C3 may amplify and output the detection signal TRX1. The signal receiver 201C3 may be implemented as an analog front end (AFE) including an operational amplifier OPA.

The signal receiver 201C3 may include the operational amplifier OPA having an inverting input terminal (-) electrically connected to the second electrode 220-1 and a non-inverting input terminal (+) to which a reference signal is applied, a capacitor Ca and a reset switch SWr connected in parallel to the inverting input terminal (-) of the operational amplifier OPA and an output terminal of the operational amplifier OPA, and a signal source VCM that provides the reference voltage to the non-inverting input terminal (+) of the operational amplifier OPA. The operational amplifier OPA may amplify and output the difference between the detection signal TRX1 received from the second electrode 220-1 and the reference voltage provided from the signal source VCM.

Each of the plurality of signal receivers 201C3 may correspond to each of the plurality of second electrodes 220-1, 220-2,220-3, ... . Each of the plurality of signal receivers 201C3 may compare the received detection signal with the reference signal, may amplify the comparison result so as to output to the at least one analog-to-digital converter 202C3. The at least one analog-to-digital converter 202C3 may convert the output of the operational amplifier OPA into a digital signal.

The signal processor 203C3 may process the digital signal received from the analog-to-digital converter 202C3 and may sense the input based on the signal processing result. The signal processor 203C3 may be implemented as a microprocessor unit (MPU) or a microcontroller unit (MCU).

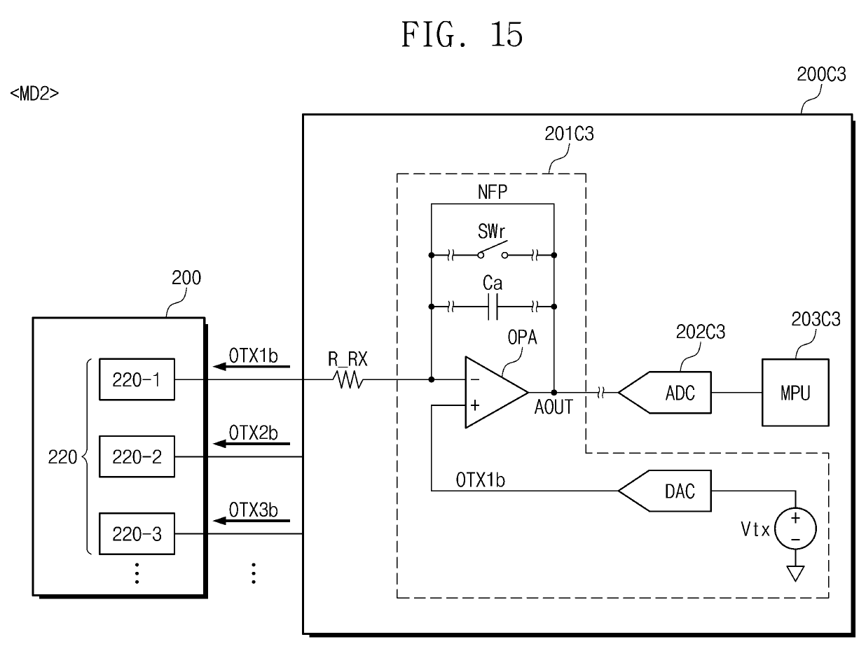

FIG. 15 is a block diagram illustrating an input detection circuit in a second mode, according to an embodiment of the present disclosure.

Referring to FIG. 15, the input detection circuit 200C3 may output a plurality of third transmission signals OTX1b, OTX2b, OTX3b, ... to the sensor layer 200 in the second mode MD2.

In the second mode MD2, a negative feedback path NFP may be activated. The negative feedback path NFP connects the inverting input terminal (-) of the operational amplifier OPA and the output terminal of the operational amplifier OPA. The operational amplifier OPA may operate as an output buffer through the negative feedback path NFP.

The input detection circuit 200C3 may output the third transmission signals OTX1b, OTX2b, OTX3b, ... to the second electrodes 220-1, 220-2, 220-3, ... in the second mode MD2, respectively. The signal receiver 201C3 included in the input detection circuit 200C3 may further include the signal source Vtx and the digital-to-analog converter DAC.

The signal source Vtx may generate a digital signal based on the received control signal, and the digital-to-analog converter DAC may generate the third transmission signal OTX1b based on the received digital signal. The third transmission signal OTX1b may be input to the non-inverting input terminal (+) of the operational amplifier OPA.

In the second mode MD2, the operational amplifier OPA may operate as a buffer. In the second mode MD2, the capacitor Ca connected in parallel to the inverting input terminal (-) and the output terminal of the operational amplifier OPA may be cut off. The signal receiver 201C3 may further include a blocking switch (not illustrated) connected in series to the capacitor Ca. The blocking switch may be turned off in the second mode MD2 to block the connection between the capacitor Ca and the operational amplifier OPA.

In the second mode MD2, the connection between the output terminal of the operational amplifier OPA and the analog-to-digital converter 202C3 may be blocked. Through this, when the operational amplifier OPA outputs the third transmission signal OTX1b in the second mode MD2, the influence of the unnecessary analog-to-digital converter 202C3 may be reduced. The input detection circuit 200C3 may further include the blocking switch (not illustrated) connected in series between the operational amplifier OPA and the analog-to-digital converter 202C3. The blocking switch is turned off in the second mode MD2 and may cut off the connection between the output terminal of the operational amplifier OPA and the analog-to-digital converter 202C3.

The input detection circuit 200C3 may output the third transmission signals OTX1b, OTX2b, OTX3b... through each of the plurality of signal receivers 201C3.

The third transmission signals OTX1b, OTX2b, OTX3b, ... may be output to the corresponding second electrodes 220-1, 220-2, 220-3, ..., respectively. The third transmission signals OTX1b, OTX2b, OTX3b, ... may be output to some or all of the first electrodes 210 as well as the second electrodes 220. For example, the input detection circuit 200C3 may output the third transmission signals OTX1b, OTX2b, OTX3b, ... to some or all of the first electrodes 210 or to some or all of the second electrodes 220 in the second mode MD2.

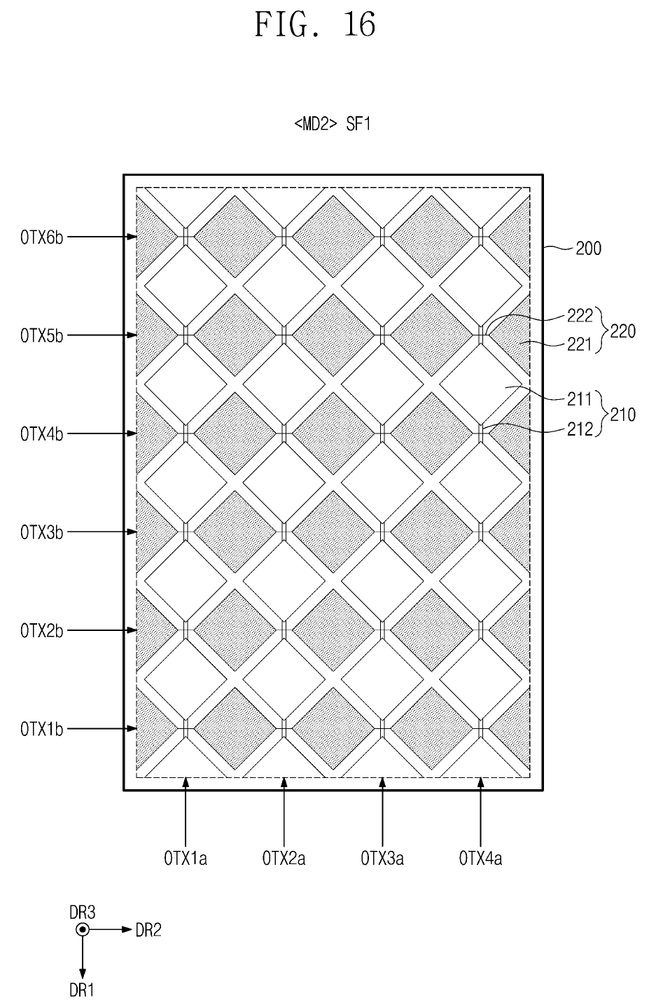

FIG. 16 is a diagram illustrating second transmission signals and third transmission signals in one sub-frame, according to an embodiment of the present disclosure.

Referring to FIGS. 5, 8, and 16, in a first sub-frame SF1 of the second mode MD2, the second transmission signals OTX1a, OTX2a, OTX3a, and OTX4a and the third transmission signals OTX1b, OTX2b, ..., and OTX6b may be applied to the sensor layer 200.

One frame may include one or more sub-frames. During one frame, encoded signals may be applied to some or all of the electrodes included in the sensor layer 200 to determine the position of the object. A sub-frame may refer to a period of time in which signals are applied simultaneously. For example, when one frame includes a first sub-frame and a second sub-frame, a subset of the signals used by the object to detect the position may be applied during the first sub- frame, and a remainder of the signals used by the object to detect the position may be applied during the second sub-frame.

During the first sub-frame SF1, each of the second transmission signals OTX1a, OTX2a, OTX3a, and OTX4a outputted by the signal generation circuit 200C2 is applied to a corresponding electrode among the first electrodes 210 which extend in the first direction DR1 and spaced apart in the second direction DR2.

During the first sub-frame SF1, each of the third transmission signals OTX1b, OTX2b, ..., and OTX6b outputted by the input detection circuit 200C3 is applied to a corresponding electrode among the second electrodes 220 which extend in the second direction DR2 and spaced apart in the first direction DR1.

The second transmission signals OTX1a, OTX2a, OTX3a, and OTX4a and the third transmission signals OTX1b, OTX2b, ..., and OTX6b may be signals encoded to include position information. The second transmission signals OTX1a, OTX2a, OTX3a, and OTX4a and the third transmission signals OTX1b, OTX2b, ..., and OTX6b act in orthogonal directions on the sensor layer 200.

The object OB outside the sensor layer 200 may receive signals corresponding to the second transmission signals OTX1a, OTX2a, OTX3a, and OTX4a and the third transmission signals OTX1b, OTX2b, ..., and OTX6b through the capacitance formed between the sensing electrode 310-E and the electrodes of the sensor layer 200 (refer to FIGS. 5 and 8). The object OB outside the sensor layer 200 may decode position information based on the signals received by the object OB. Through this, during the first sub-frame SF1, the object OB may determine its position relative to the sensor layer 200. In a sub-frame, the object OB may determine its position, and operation time in the second mode MD2 for transmitting a signal to the external object may be shortened.

According to an embodiment of the present disclosure, the sensor layer 200 does not receive the output signal O-RX provided from the object OB in the second mode MD2 and, instead, the output signal O-RX is provided directly to main driver 1000C.. Since the operation (or period) for receiving the output signal O-RX is omitted, the sensor driver 200C may simultaneously output the second transmission signals OTX1a, OTX2a, OTX3a, and OTX4a and the third transmission signals OTX1b, OTX2b, ..., and OTX6b to the sensor layer 200.

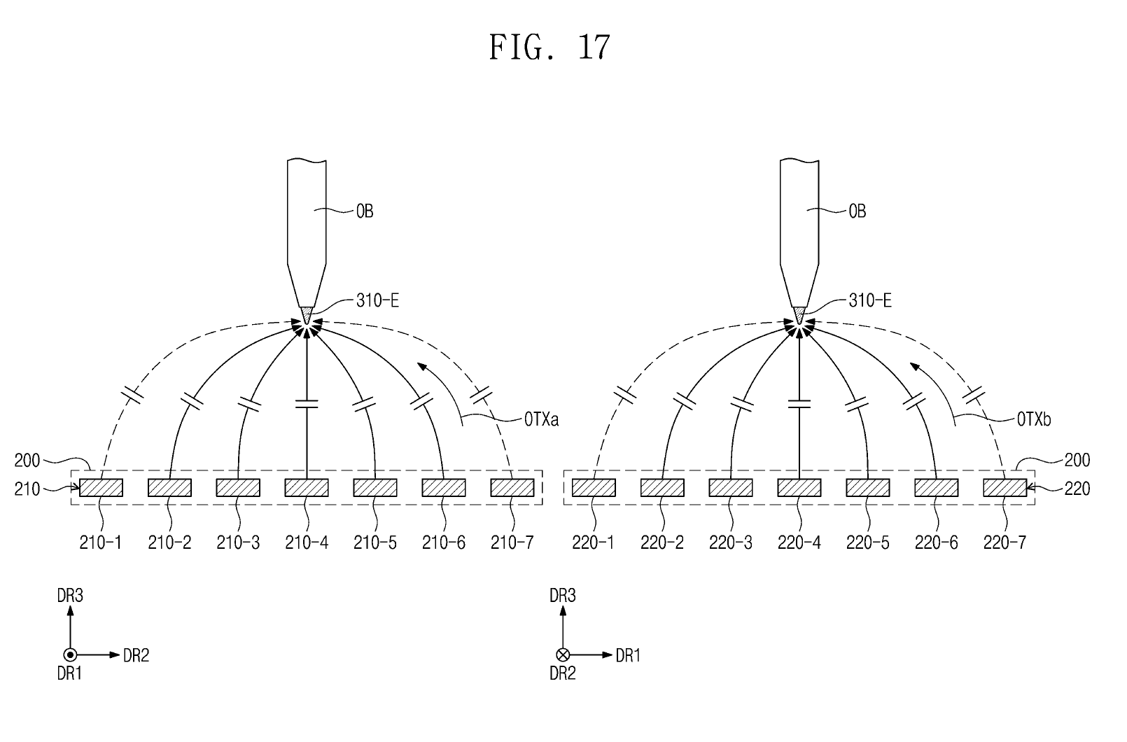

FIG. 17 is a diagram illustrating an interface system, according to an embodiment of the present disclosure.

Referring to FIGS. 5 and 17, the object OB may receive the first signal OTXa from the first electrodes 210 spaced apart in the second direction DR2, and may receive the second signal OTXb from the second electrodes 220 spaced apart in the first direction DR1.

The first signal OTXa is a signal obtained by a signal applied to the first electrodes 210 among the second transmission signals OTX1a, OTX2a, OTX3a, ... and the third transmission signals OTX1b, OTX2b, OTX3b, ... . The second signal OTXb is a signal obtained by a signal applied to the second electrodes 220 among the second transmission signals OTX1a, OTX2a, OTX3a, ... and the third transmission signals OTX1b, OTX2b, OTX3b, ... .

The sensing electrode 310-E of the object OB may form a capacitance with the first electrodes 210 and the second electrodes 220 included in the sensor layer 200. The sensing electrode 310-E of the object OB may receive a signal in which the first signal OTXa and the second signal OTXb are superposed. The object OB may determine its position on the sensor layer 200 by decoding the signal in which the first signal OTXa and the second signal OTXb are superposed.

According to an embodiment of the present disclosure, signals for detecting the position of the object OB are output simultaneously during a sub-frame to the first direction DR1 and the second direction DR2, and the object OB may determine the position of the object based on the superposed signals received during the single sub-frame. Through this, the operation time of the second mode may be reduced.

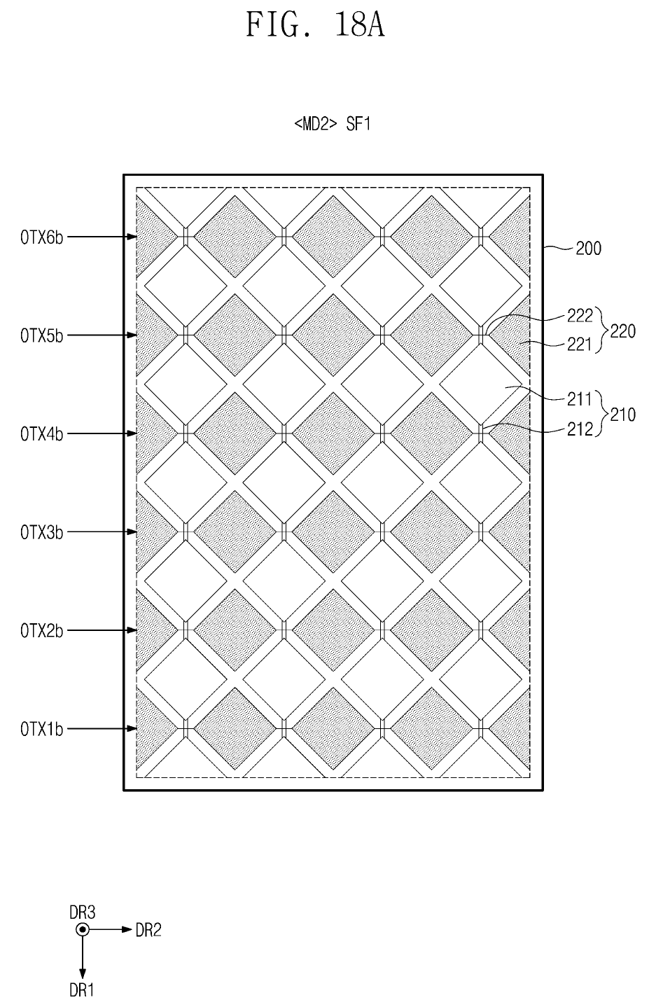

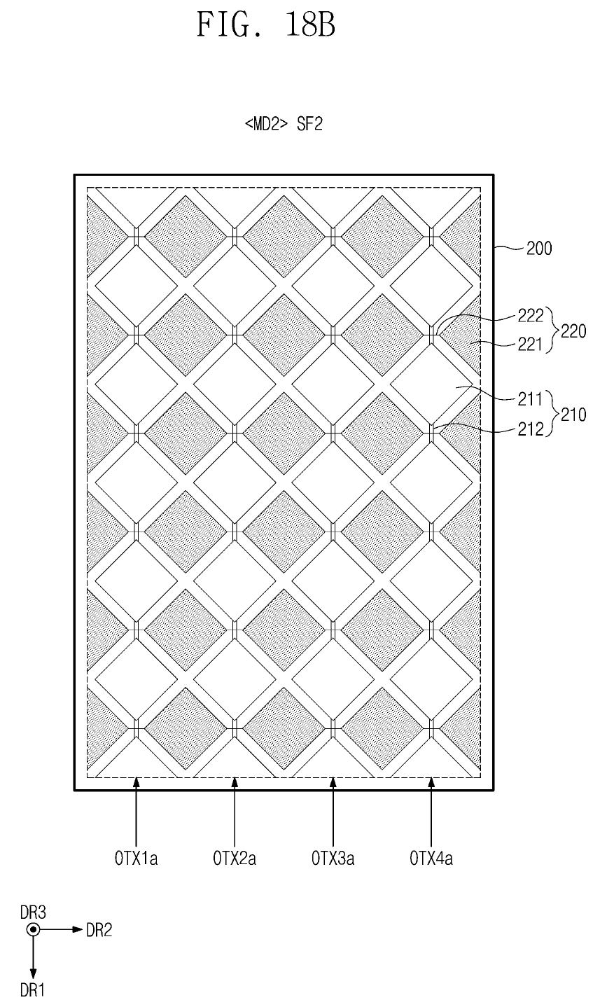

FIG. 18A is a diagram illustrating third transmission signals received by a sensor layer in a first sub-frame, according to an embodiment of the present disclosure. FIG. 18B is a diagram illustrating second transmission signals received by a sensor layer in a second sub-frame, according to an embodiment of the present disclosure.

Referring to FIGS. 5, 17, 18A, and 18B, in the second mode MD2, one frame may include the first sub-frame SF1 and a second sub-frame SF2.

During the first sub-frame SF1, each of the third transmission signals OTX1b, OTX2b, ..., and OTX6b output from the input detection circuit 200C3 may be applied to a corresponding electrode among the second electrodes 220 included in the sensor layer 200.

During the second sub-frame SF2, each of the second transmission signals OTX1a, OTX2a, OTX3a, and OTX4a output from the signal generation circuit 200C2 may be applied to a corresponding electrode among the first electrodes 210 included in the sensor layer 200.

Although FIGS. 18A and 18B illustrate that the third transmission signals OTX1b, OTX2b, ..., and OTX6b are applied in the first sub-frame SF1 and the second transmission signals OTX1a, OTX2a, OTX3a, and OTX4a are applied in the second sub-frame SF2, the order of the first sub-frame SF1 and the second sub-frame SF2 may be changed. For example, the third transmission signals OTX1b, OTX2b, ..., and OTX6b may be applied during the preceding sub-frame and the second transmission signals OTX1a, OTX2a, OTX3a, and OTX4a may be applied during the subsequent sub-frame.

According to an embodiment of the present disclosure, the position of the first direction DR1 on the sensor layer 200 may be determined during the first sub-frame SF1, and the position of the second direction DR2 on the sensor layer 200 may be determined during the second sub-frame SF2.

According to an embodiment of the present disclosure, the sensor layer 200 does not receive the output signal O-RX provided from the object OB in the second mode MD2 and, instead, the output signal O-RX is provided directly to the main driver 1000C. Since the operation (or period) for receiving the output signal O-RX is omitted, the first sub-frame SF1 and the second sub-frame SF2 may be consecutive to each other. For example, the sensor layer 200 may be operated with the second sub-frame SF2 immediately following the first sub-frame SF1, or with the first sub-frame SF1 immediately following the second sub-frame SF2.

In an embodiment of the present disclosure, one frame may include three sub-frames. For example, in the first sub-frame, the second transmission signals OTX1a, OTX2a, OTX3a, and OTX4a may be output, in the second sub-frame, a subset of third transmission signals OTX1b, OTX2b, ..., and OTX6b, for example, third transmission signals OTX1b, OTX2b, and OTX3b may be output, and in the third sub-frame, a remainder of the third transmission signalOTX1b, OTX2b, ..., and OTX6b, for example, third transmission signals OTX4b, OTX5b, and OTX6b may be output.

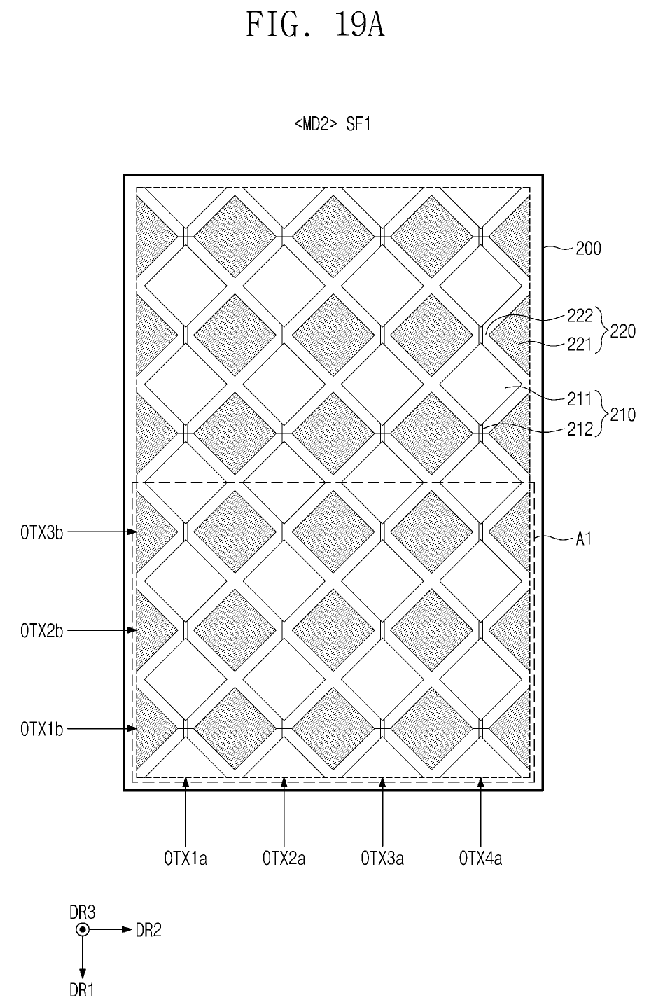

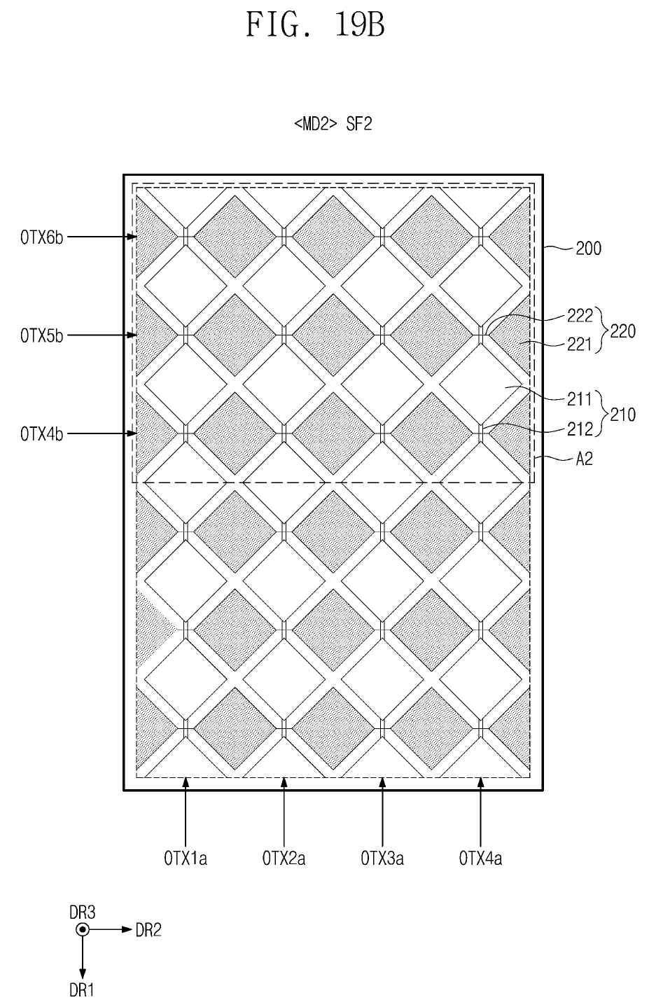

FIG. 19A is a diagram illustrating second transmission signals and third transmission signals received by a sensor layer in a first sub-frame, according to an embodiment of the present disclosure. FIG. 19B is a diagram illustrating second transmission signals and third transmission signals received by a sensor layer in a second sub-frame, according to an embodiment of the present disclosure.

Referring to FIGS. 5, 17, 19A, and 19B, one frame may include the first sub-frame SF1 and the second sub-frame SF2.

During the first sub-frame SF1, the first subset OTX1b, OTX2b, and OTX3b of the third transmission signals OTX1b, OTX2b, ..., and OTX6b may be applied to the sensor layer 200, and during the second sub-frame SF2, the second subset OTX4b, OTX5b, and OTX6b of the third transmission signals OTX1b, OTX2b, ..., and OTX6b may be applied to the sensor layer 200.

During the first sub-frame SF1, the second transmission signals OTX1a, OTX2a, OTX3a, and OTX4a output from the signal generation circuit 200C2 may be applied to the corresponding first electrodes 210 included in the sensor layer 200. During the first sub-frame SF1, the first subset of the third transmission signals OTX1b, OTX2b, and OTX3b output from the input detection circuit 200C3 may be applied to corresponding electrodes among the second electrodes 220 included in the sensor layer 200, respectively. A first area A1 is an area corresponding to the third transmission signals OTX1b, OTX2b, and OTX3b among the sensor layer 200. When the object exists on the first area A1, the position of the object may be determined in the first sub-frame SF1.

During the second sub-frame SF2, the second transmission signals OTX1a, OTX2a, OTX3a, and OTX4a output from the signal generation circuit 200C2 may be applied to the corresponding first electrodes 210 included in the sensor layer 200. During the second sub-frame SF2, the second subset of the third transmission signals OTX4b, OTX5b, and OTX6b output from the input detection circuit 200C3 may be applied to corresponding electrodes among the second electrodes 220 included in the sensor layer 200, respectively. A second area A2 is an area corresponding to the third transmission signals OTX4b, OTX5b, and OTX6b among the sensor layer 200. When the object exists on the second area A2, the position of the object may be determined in the second sub-frame SF2.

FIGS. 19A and 19B illustrate that signals are applied to the first area A1 in the first sub-frame SF1, and signals are applied to the second area A2 in the second sub-frame SF2. However, the embodiment is not limited to above description, signals may be applied to the second area A2 in the first sub-frame SF1, and signals may be applied to the first area A1 in the second sub-frame SF2.

Through this, signals for determining the position of the object may be applied by dividing the entire area of the sensor layer 200 into the first area A1 and the second area A2. Through this, the power consumption required for one sub-frame may be reduced.

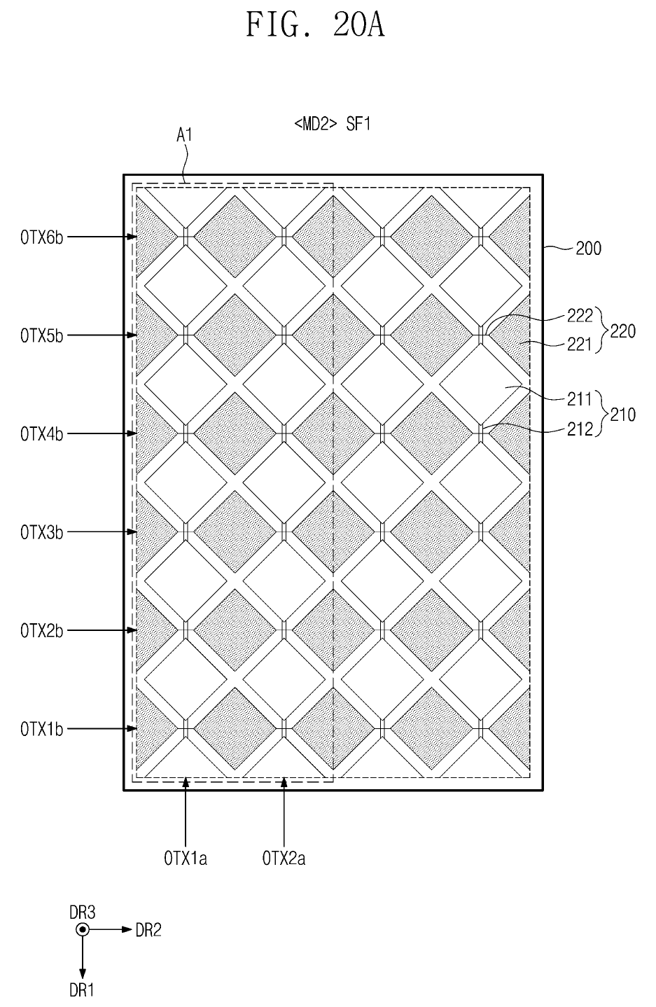

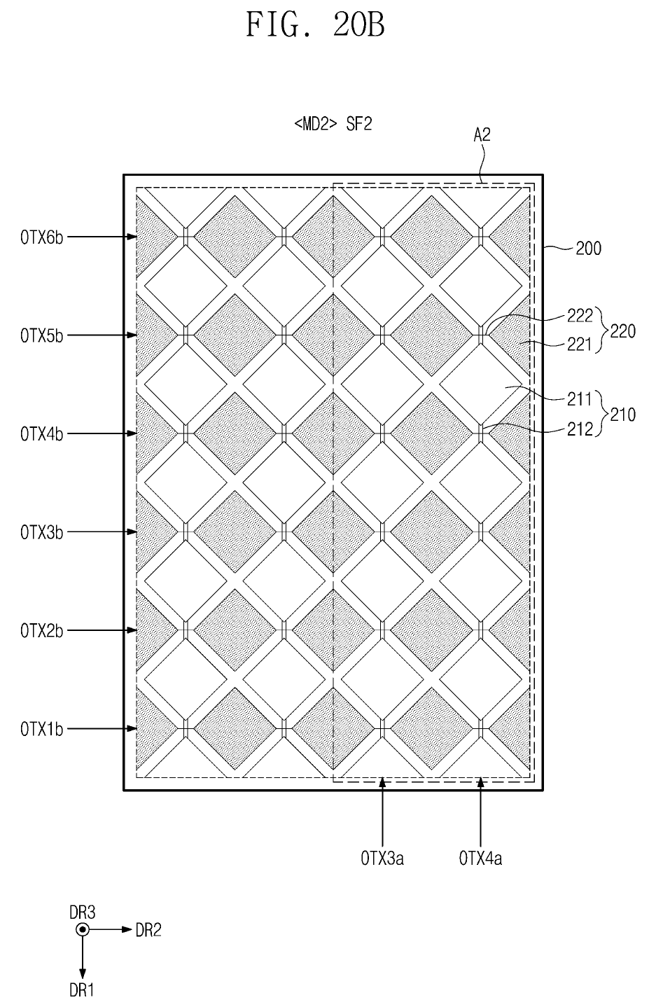

FIG. 20A is a diagram illustrating second transmission signals and third transmission signals received by a sensor layer in a first sub-frame, according to an embodiment of the present disclosure. FIG. 20B is a diagram illustrating second transmission signals and third transmission signals received by a sensor layer in a second sub-frame, according to an embodiment of the present disclosure.

Referring to FIGS. 20A and 20B, one frame may include the first sub-frame SF1 and the second sub-frame SF2.

During the first sub-frame SF1, a first subset OTX1a and OTX2a of the second transmission signals OTX1a, OTX2a, OTX3a, andOTX4a may be applied, and during the second sub-frame SF2, a second subset OTX3a and OTX4a of the second transmission signals OTX1a, OTX2a, OTX3a, andOTX4a may be applied.

During the first sub-frame SF1, the first subset of the second transmission signals OTX1a and OTX2a output from the signal generation circuit 200C2 may be applied to corresponding electrodes among the first electrodes 210 included in the sensor layer 200, respectively. During the first sub-frame SF1, the third transmission signals OTX1b, OTX2b, ..., and OTX6b output from the input detection circuit 200C3 may be applied to each of the second electrodes 220 included in the sensor layer 200. The first area A1 is an area corresponding to the second transmission signals OTX1a and OTX2a among the sensor layer 200. When the object exists on the first area A1, the position of the object may be determined in the first sub-frame SF1.

During the second sub-frame SF2, the second subset of the second transmission signals OTX3a and OTX4a output from the signal generation circuit 200C2 may be applied to corresponding electrodes among the first electrodes 210 included in the sensor layer 200, respectively. During the second sub-frame SF2, the third transmission signals OTX1b, OTX2b, ..., and OTX6b output from the input detection circuit 200C3 may be applied to the corresponding second electrodes 220 included in the sensor layer 200. The second area A2 is an area corresponding to the second transmission signals OTX3a and OTX4a among the sensor layer 200. When the object exists on the second area A2, the position of the object may be determined in the second sub-frame SF2.

FIGS. 20A and 20B illustrate that signals are applied to the first area A1 in the first sub-frame SF1 and signals are applied to the second area A2 in the second sub-frame SF2. However, without being limited thereto, signals may be applied to the second area A2 in the first sub-frame SF1, and signals may be applied to the first area A1 in the second sub-frame SF2.

Through this, the signal for determining the position of the object may be applied by dividing the entire area of the sensor layer 200 into the first area A1 and the second area A2. Through this, the power consumption required for one sub-frame may be reduced.

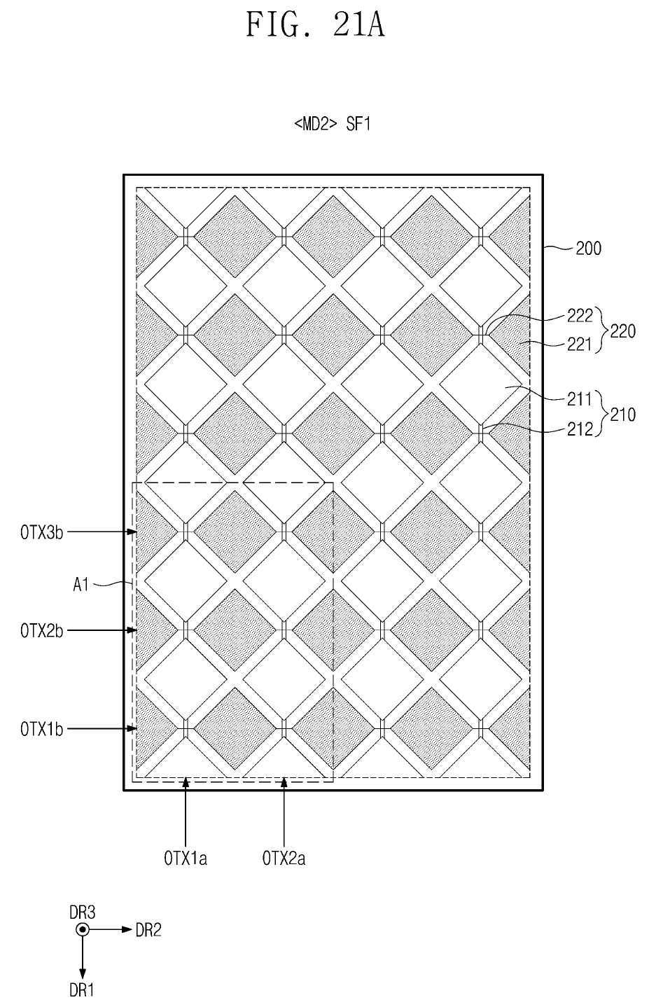

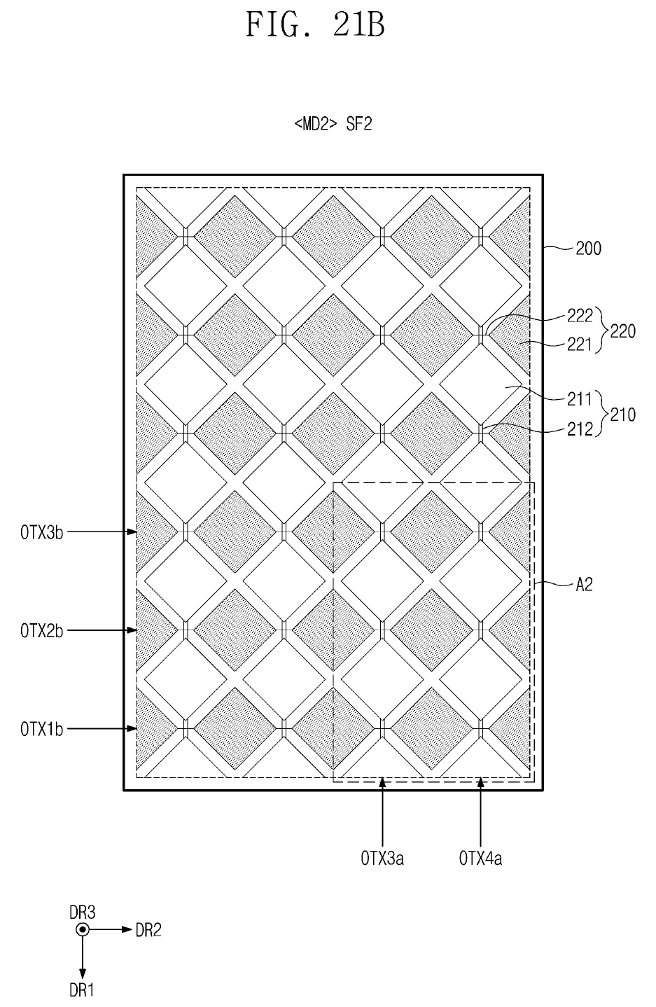

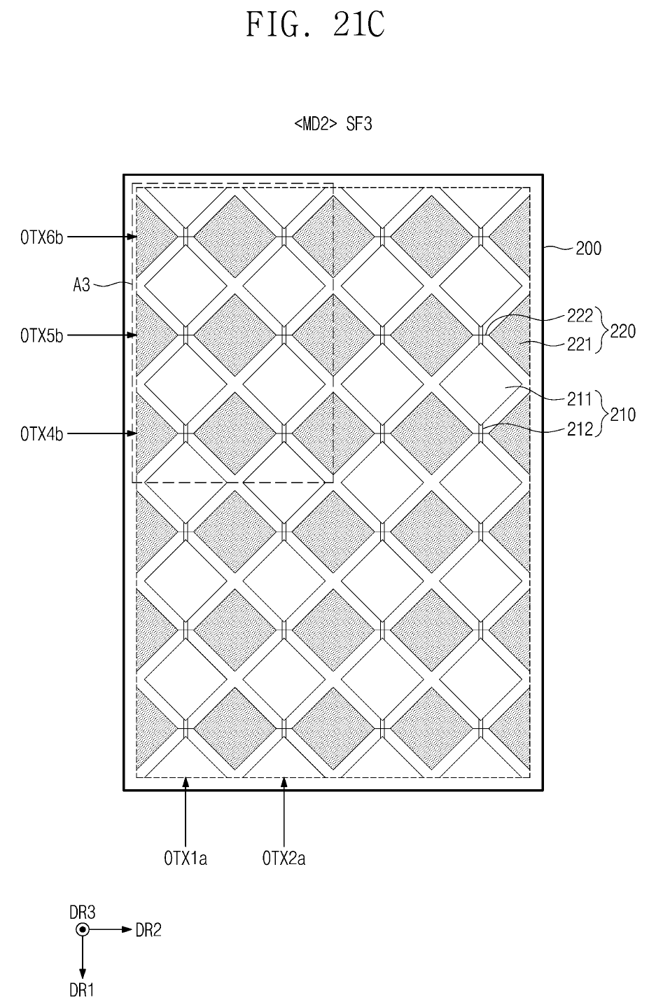

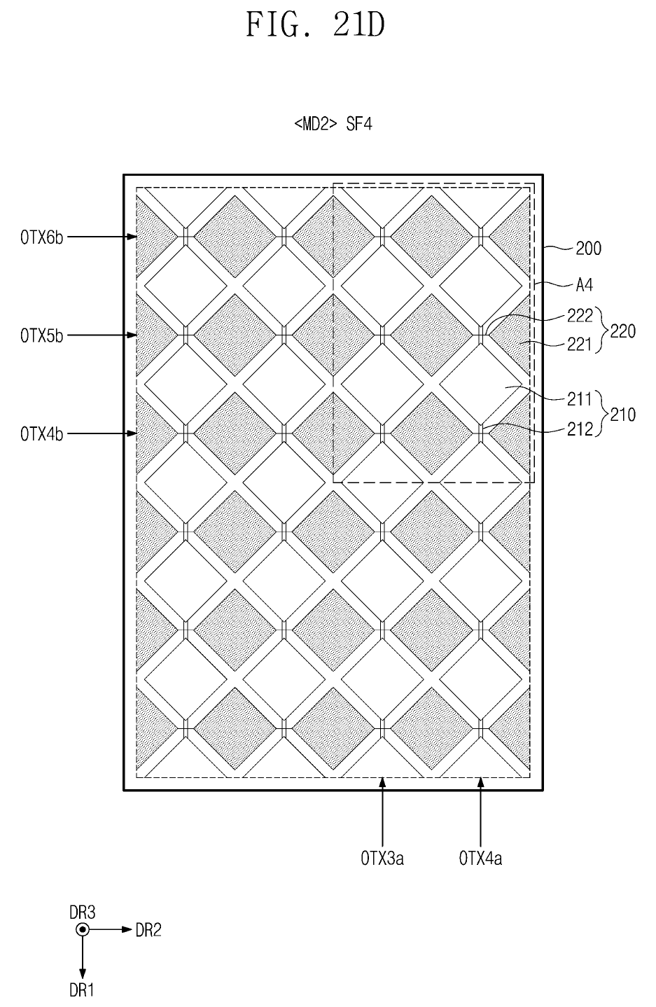

FIG. 21A is a diagram illustrating second transmission signals and third transmission signals received by a sensor layer in a first sub-frame, according to an embodiment of the present disclosure. FIG. 21B is a diagram illustrating second transmission signals and third transmission signals received by a sensor layer in a second sub-frame, according to an embodiment of the present disclosure. FIG. 21C is a diagram illustrating second transmission signals and third transmission signals received by a sensor layer in a third sub-frame, according to an embodiment of the present disclosure. FIG. 21D is a diagram illustrating second transmission signals and third transmission signals received by a sensor layer in a fourth sub-frame, according to an embodiment of the present disclosure.

Referring to FIGS. 5, 17, and 21A to 21D, one frame may include the first sub-frame SF1 to a fourth sub-frame SF4.

Transmission signals corresponding to preset areas may be applied during the first sub-frame SF1 to the fourth sub-frame SF4.

During the first sub-frame SF1, the second transmission signals OTX1a and OTX2a output from the signal generation circuit 200C2 may be applied to corresponding electrodes among the first electrodes 210 included in the sensor layer 200, respectively. During the first sub-frame SF1, the third transmission signals OTX1b, OTX2b, and OTX3b output from the input detection circuit 200C3 may be applied to corresponding electrodes among the second electrodes 220 included in the sensor layer 200, respectively. The first area A1 is an area corresponding to the second transmission signals OTX1a and OTX2a and the third transmission signals OTX1b, OTX2b, and OTX3b among the sensor layer 200. When the object exists on the first area A1, the position of the object may be determined in the first sub-frame SF1.

During the second sub-frame SF2, the second transmission signals OTX3a and OTX4a output from the signal generation circuit 200C2 may be applied to corresponding electrodes among the first electrodes 210 included in the sensor layer 200, respectively. During the second sub-frame SF2, the third transmission signals OTX1b, OTX2b, and OTX3b output from the input detection circuit 200C3 may be applied to corresponding electrodes among the second electrodes 220 included in the sensor layer 200, respectively. The second area A2 is an area corresponding to the second transmission signals OTX3a and OTX4a and the third transmission signals OTX1b, OTX2b, and OTX3b among the sensor layer 200. When the object exists on the second area A2, the position of the object may be determined in the second sub-frame SF2.

During the third sub-frame SF3, the second transmission signals OTX1a and OTX2a output from the signal generation circuit 200C2 may be applied to corresponding electrodes among the first electrodes 210 included in the sensor layer 200, respectively. During the third sub-frame SF3, the third transmission signals OTX4b, OTX5b, and OTX6b output from the input detection circuit 200C3 may be applied to corresponding electrodes among the second electrodes 220 included in the sensor layer 200, respectively. A third area A3 is an area corresponding to the second transmission signals OTX1a and OTX2a and the third transmission signals OTX4b, OTX5b, and OTX6b among the sensor layer 200. When the object exists on the third area A3, the position of the object may be determined in the third sub-frame SF3.

During the fourth sub-frame SF4, the second transmission signals OTX3a and OTX4a output from the signal generation circuit 200C2 may be applied to corresponding electrodes among the first electrodes 210 included in the sensor layer 200, respectively. During the fourth sub-frame SF4, the third transmission signals OTX4b, OTX5b, and OTX6b output from the input detection circuit 200C3 may be applied to corresponding electrodes among the second electrodes 220 included in the sensor layer 200, respectively. A fourth area A4 is an area corresponding to the second transmission signals OTX3a and OTX4a and the third transmission signals OTX4b, OTX5b, and OTX6b among the sensor layer 200. When the object exists on the fourth area A4, the position of the object may be determined in the fourth sub-frame SF4.

FIGS. 21A to 21D illustrate that signals are applied to the first area A1 in the first sub-frame SF1, signals are applied to the second area A2 in the second sub-frame SF2, signals are applied to the third area A3 in the third sub-frame SF3, and signals are applied to the fourth area A4 in the fourth sub-frame SF4. However, the embodiment is not limited to above descriptions, and the order of the first area A1 to the fourth area A4 where signals are output in each of the first sub-frame SF1 to the fourth sub-frame SF4 may be changed.

Through this, signals for determining the position of the object may be applied by dividing the entire area of the sensor layer 200 into the first area A1 to the fourth area A4. Through this, the power consumption required for one sub-frame may be reduced.

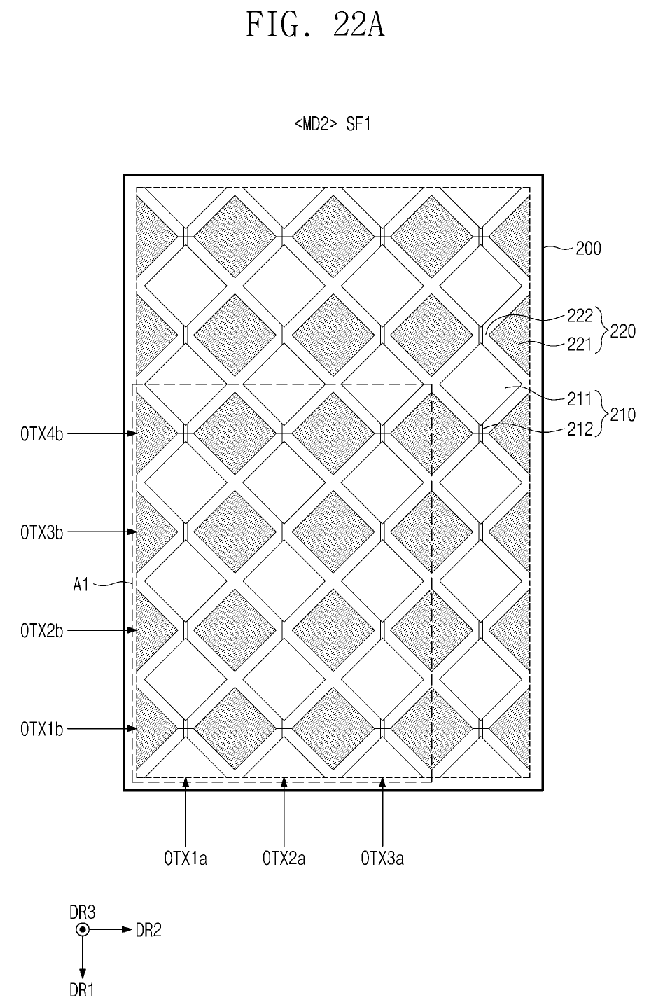

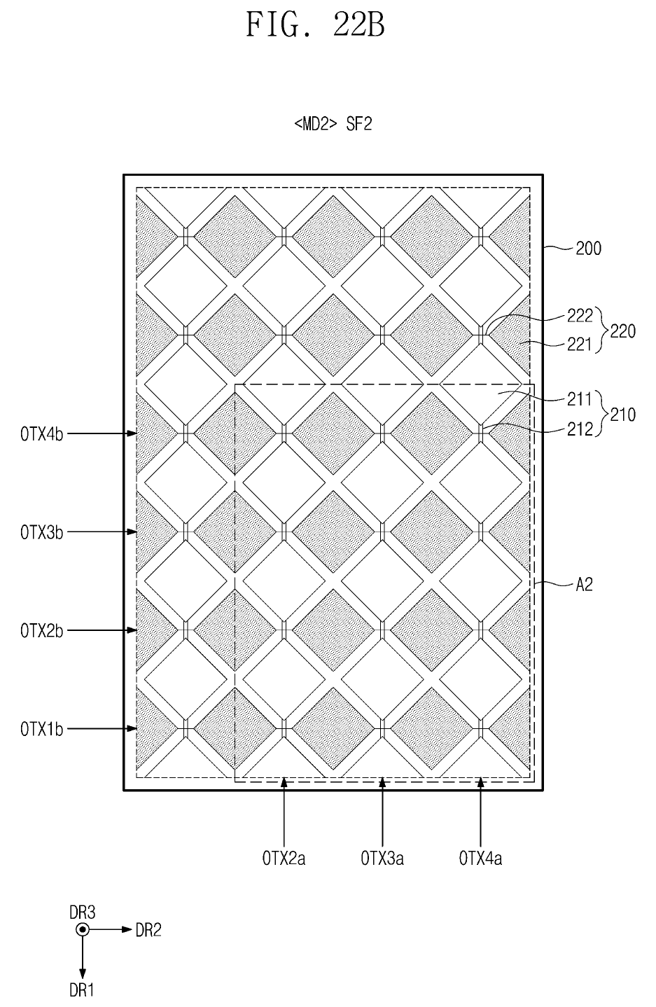

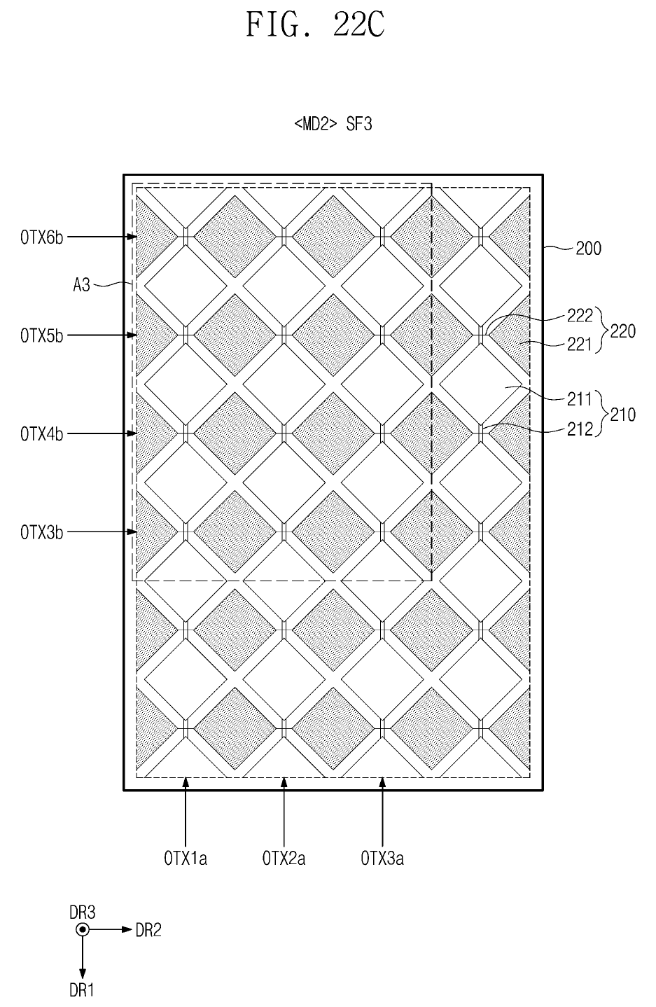

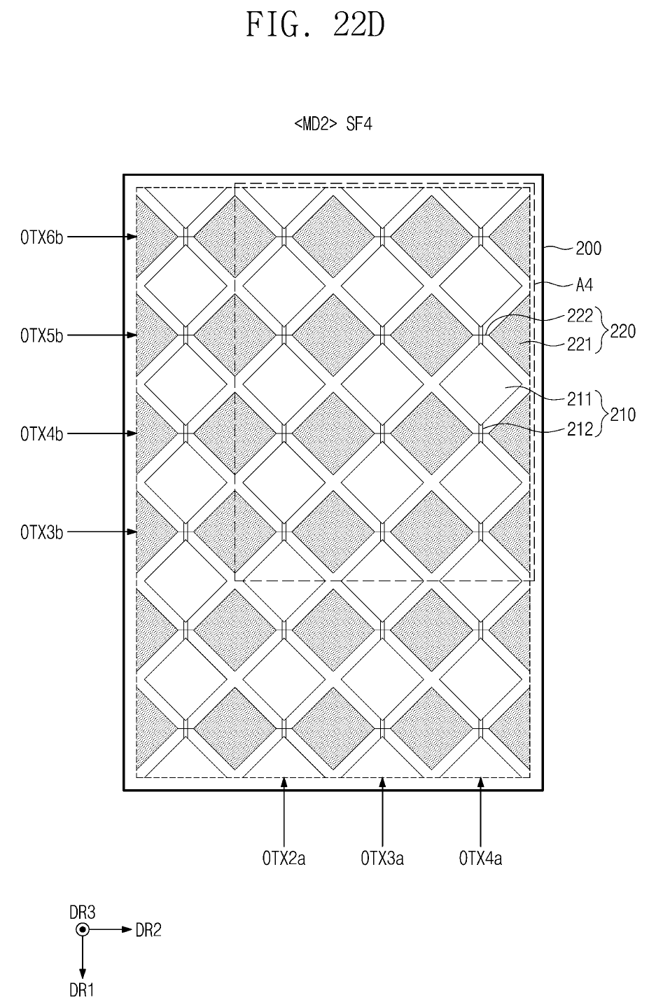

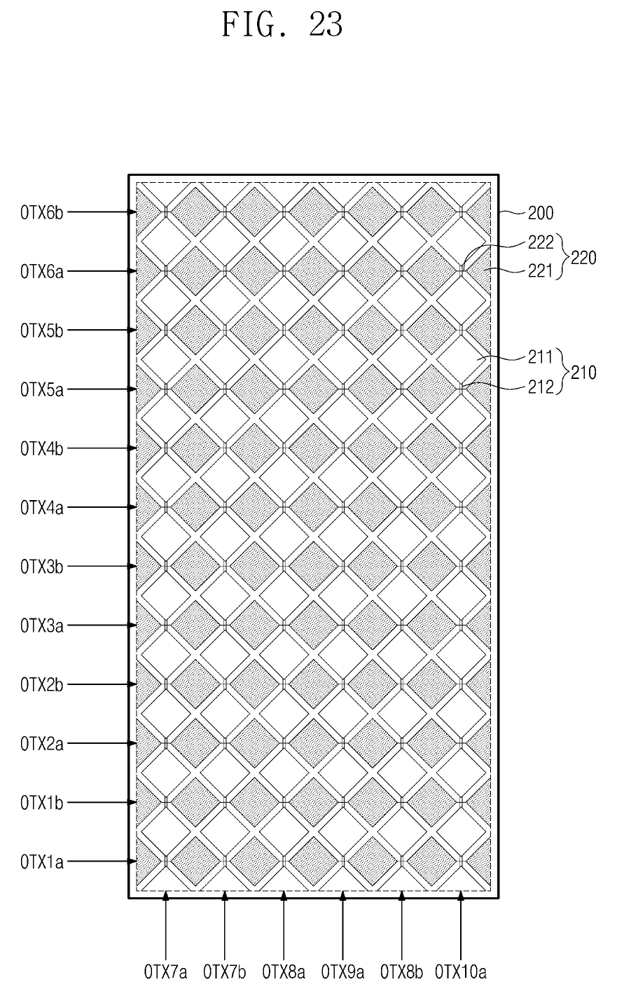

FIG. 22A is a diagram illustrating second transmission signals and third transmission signals received by a sensor layer in the first sub-frame SF1, according to an embodiment of the present disclosure. FIG. 22B is a diagram illustrating second transmission signals and third transmission signals received by a sensor layer in a second sub-frame, according to an embodiment of the present disclosure. FIG. 22C is a diagram illustrating second transmission signals and third transmission signals received by a sensor layer in a third sub-frame, according to an embodiment of the present disclosure. FIG. 22D is a diagram illustrating second transmission signals and third transmission signals received by a sensor layer in a fourth sub-frame, according to an embodiment of the present disclosure.

Referring to FIGS. 5, 17, and 22A to 22D, one frame may include the first sub-frame SF1 to the fourth sub-frame SF4.

In the first sub-frame SF1 to the fourth sub-frame SF4, each of the areas A1, A2, A3, and A4 may share at least one electrode with adjacent areas A1, A2, A3, and A4. For example, the first area A1 and the second area A2 may share electrodes to which the second transmission signals OTX2a and OTX3a are applied. The first area A1 and the third area A3 may share electrodes to which the third transmission signals OTX3b and OTX4b are applied.

During the first sub-frame SF1, the second transmission signals OTX1a, OTX2a, and OTX3a output from the signal generation circuit 200C2 may be applied to corresponding electrodes among the first electrodes 210 included in the sensor layer 200, respectively. During the first sub-frame SF1, the third transmission signals OTX1b, OTX2b, OTX3b, and OTX4b output from the input detection circuit 200C3 may be applied to corresponding electrodes among the second electrodes 220 included in the sensor layer 200, respectively. The first area A1 is a region corresponding to the second transmission signals OTX1a, OTX2a, and OTX3a and the third transmission signals OTX1b, OTX2b, OTX3b, and OTX4b among the sensor layer 200. When the object exists on the first area A1, the position of the object may be determined in the first sub-frame SF1.

During the second sub-frame SF2, the second transmission signals OTX2a, OTX3a, and OTX4a output from the signal generation circuit 200C2 may be applied to corresponding electrodes among the first electrodes 210 included in the sensor layer 200, respectively. During the second sub-frame SF2, the third transmission signals OTX1b, OTX2b, OTX3b, and OTX4b output from the input detection circuit 200C3 may be applied to corresponding electrodes among the second electrodes 220 included in the sensor layer 200, respectively. The second area A2 is a region corresponding to the second transmission signals OTX2a, OTX3a, and OTX4a and the third transmission signals OTX1b, OTX2b, OTX3b, and OTX4b among the sensor layer 200. When the object exists on the second area A2, the position of the object may be determined in the second sub-frame SF2.

During the third sub-frame SF3, the second transmission signals OTX1a, OTX2a, and OTX3a output from the signal generation circuit 200C2 may be applied to corresponding electrodes among the first electrodes 210 included in the sensor layer 200, respectively. During the third sub-frame SF3, the third transmission signals OTX3b, OTX4b, OTX5b, and OTX6b output from the input detection circuit 200C3 may be applied to corresponding electrodes among the second electrodes 220 included in the sensor layer 200, respectively. The third area A3 is a region corresponding to the second transmission signals OTX1a, OTX2a, and OTX3a and the third transmission signals OTX3b, OTX4b, OTX5b, and OTX6b among the sensor layer 200. When the object exists on the third area A3, the position of the object may be determined in the third sub-frame SF3.

During the fourth sub-frame SF4, the second transmission signals OTX2a, OTX3a and OTX4a output from the signal generation circuit 200C2 may be applied to corresponding electrodes among the first electrodes 210 included in the sensor layer 200, respectively. During the fourth sub-frame SF4, the third transmission signals OTX3b, OTX4b, OTX5b, and OTX6b output from the input detection circuit 200C3 may be applied to corresponding electrodes among the second electrodes 220 included in the sensor layer 200, respectively. The fourth area A4 is a region corresponding to the second transmission signals OTX2a, OTX3a and OTX4a and the third transmission signals OTX3b, OTX4b, OTX5b, and OTX6b among the sensor layer 200. When the object exists on the fourth area A4, the position of the object may be determined in the fourth sub-frame SF4.

Areas A1, A2, A3, and A4 where signals are output during the first sub-frame SF1 to the fourth sub-frame SF4 have superposed portions. For example, areas corresponding to the second transmission signals OTX2a and OTX3a and the third transmission signals OTX1b, OTX2b, OTX3b, and OTX4b are included in the first area A1 and the second area A2, respectively. Areas corresponding to the second transmission signals OTX1a, OTX2a, and OTX3a and the third transmission signals OTX3b and OTX4b are included in the first area A1 and the third area A3, respectively. When an object exists at the boundary of the first area A1, the position of the object may also be determined in the superposed portion of each of the second area A2 to the fourth area A4. That is, the precision of the position of the object in the boundary area or the position detection characteristic of the object may be improved.

FIGS. 22A to 22D illustrate that signals are applied to the first area A1 in the first sub-frame SF1, signals are applied to the second area A2 in the second sub-frame SF2, signals are applied to the third area A3 in the third sub-frame SF3, and signals are applied to the fourth area A4 in the fourth sub-frame SF4. However, the embodiment is not limited to above descriptions, and the order of the first area A1 to the fourth area A4 where signals are output in each of the first sub-frame SF1 to the fourth sub-frame SF4 may be changed.

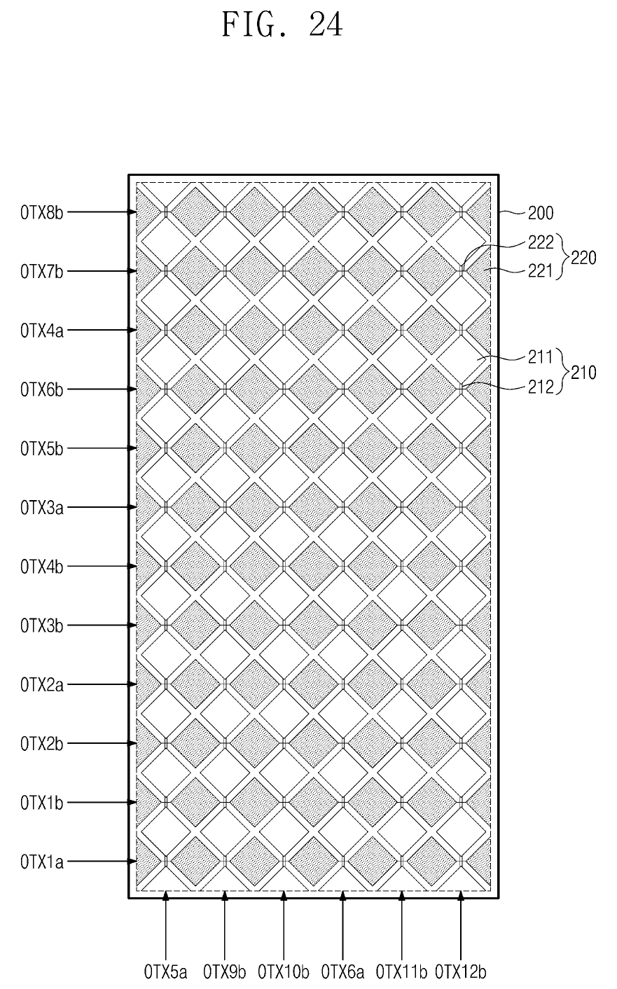

FIG. 23 is a diagram illustrating second transmission signals and third transmission signals in a sub-frame, according to an embodiment of the present disclosure.

Referring to FIG. 12 and FIG. 23, in the first sub-frame SF1 of the second mode MD2, the second transmission signals OTX1a, OTX2a, ..., and OTX10a and the third transmission signals OTX1b, OTX2b, ..., and OTX8b may be applied to the sensor layer 200.

The second transmission signals OTX1a, OTX2a ..., and OTX10a and the third transmission signals OTX1b, OTX2b, ..., and OTX8b may be applied alternately in the first direction DR1 and the second direction DR2, respectively.

During the first sub-frame SF1, the second transmission signal OTX1a, the third transmission signal OTX1b, the second transmission signal OTX2a, the third transmission signal OTX2b, the second transmission signal OTX3a, and the third transmission signal OTX3b may be alternately applied to corresponding electrodes among the second electrodes 220 spaced apart in the first direction DR1 of the sensor layer 200. The second transmission signals OTX4a, OTX5a, and OTX6a and the third transmission signals OTX4b, OTX5b, and OTX6b may also be alternately applied to corresponding electrodes among the second electrodes 220.

During the first sub-frame SF1, the second transmission signal OTX7a, the third transmission signal OTX7b, and the second transmission signal OTX8a may be alternately applied to the corresponding electrodes among the first electrodes 210 spaced apart in the second direction DR2 of the sensor layer 200. During the first sub-frame SF1, the second transmission signal OTX9a, the third transmission signal OTX8b, and the second transmission signal OTX10a may be alternately applied to the corresponding electrodes among the first electrodes 210 spaced apart in the second direction DR2 of the sensor layer 200.

The second transmission signals OTX1a, OTX2a, ..., and OTX10a are signals output by the signal generation circuit 200C2. The third transmission signals OTX1b, OTX2b, ..., and OTX8b are signals output by the input detection circuit 200C3. Therefore, the second transmission signals OTX1a, OTX2a, ..., and OTX10a have similar electrical and signal characteristics to each other, and the third transmission signals OTX1b, OTX2b, ..., and OTX8b have similar electrical and signal characteristics to each other. By alternately applying the second transmission signals OTX1a, OTX2a, ..., and OTX10a and the third transmission signals OTX1b, OTX2b, ..., and OTX8b, the difference in electrical and signal characteristics between the signal generation circuit 200C2 and the input detection circuit 200C3 may be reduced. When the sensor driver 200C alternately applies the second transmission signals OTX1a, OTX2a, ..., and OTX10a and the third transmission signals OTX1b, OTX2b, ..., and OTX8b, the signals may be applied after being divided into a plurality of sub-frames similar to the method described with reference to FIGS. 18A to 22D.

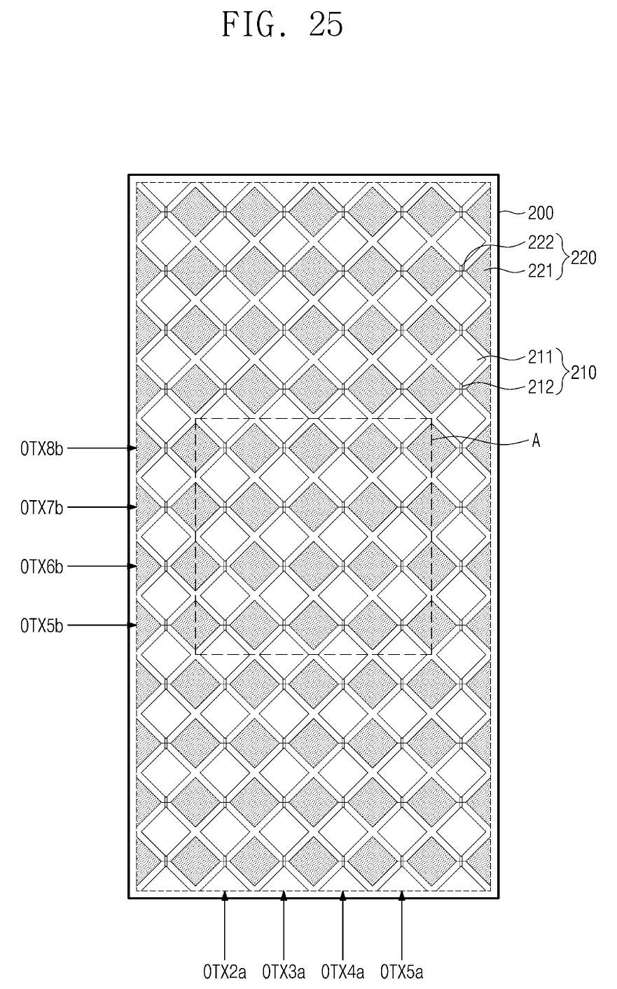

FIG. 24 is a diagram illustrating second transmission signals and third transmission signals in a sub-frame, according to an embodiment of the present disclosure.

Referring to FIG. 24, in the first sub-frame SF1 of the second mode MD2, the second transmission signals OTX1a, OTX2a, …, and OTX6a and the third transmission signals OTX1b, OTX2b, ..., and OTX12b may be applied to the sensor layer 200.

The second transmission signals OTX1a, OTX2a, ..., and OTX6a and the third transmission signals OTX1b, OTX2b, ..., and OTX12b may be applied alternately in the first direction DR1 and the second direction DR2, respectively. In this case, the second transmission signals OTX1a, OTX2a, ..., and OTX6a and the third transmission signals OTX1b, OTX2b, ..., and OTX12b may be alternately applied to the first electrodes 210 and the second electrodes 220 at a specific ratio. Hereinafter, a case in which the second transmission signals OTX1a, OTX2a, ..., and OTX6a and the third transmission signals OTX1b, OTX2b, ..., and OTX12b are alternately applied at a ratio of 1:2 will be described. The ratio of the second transmission signals OTX1a, OTX2a, ..., and OTX6a and the third transmission signals OTX1b, OTX2b, ..., and OTX12b may have various ratios such as 2:1, 2:2, 1:3, 3:1, etc., in addition to 1:2.

During the first sub-frame SF1, the second transmission signal OTX1a, the third transmission signal OTX1b, the third transmission signal OTX2b, the second transmission signal OTX2a, the third transmission signal OTX3b, and the third transmission signal OTX4b may be alternately applied to corresponding electrodes among the second electrodes 220 spaced apart in the first direction DR1 of the sensor layer 200. The second transmission signals OTX3a and OTX4a and the third transmission signals OTX5b, OTX6b, OTX7b, and OTX8b may also be alternately applied to corresponding electrodes among the second electrodes 220.

During the first sub-frame SF1, the second transmission signal OTX5a, the third transmission signal OTX9b, the third transmission signal OTX10b, the second transmission signal OTX6a, the third transmission signal OTX11b, and the third transmission signal OTX12b may be alternately applied to corresponding electrodes among the first electrodes 210 spaced apart in the second direction DR2 of the sensor layer 200.

The second transmission signals OTX1a, OTX2a, ..., and OTX6a are signals output by the signal generation circuit 200C2. The third transmission signals OTX1b, OTX2b, ..., and OTX12b are signals output by the input detection circuit 200C3. Therefore, the second transmission signals OTX1a, OTX2a, ..., and OTX6a have similar electrical and signal characteristics to each other, and the third transmission signals OTX1b, OTX2b, ..., and OTX12b have similar electrical and signal characteristics to each other. By alternately applying the second transmission signals OTX1a, OTX2a, ..., and OTX10a and the third transmission signals OTX1b, OTX2b, ..., and OTX8b, the difference in electrical and signal characteristics between the signal generation circuit 200C2 and the input detection circuit 200C3 may be reduced.

When driving for input sensing is performed in the first mode MD1, the number of input/output terminals of the input detection circuit 200C3 may be greater than the number of input/output terminals of the signal generation circuit 200C2. The second transmission signals OTX1a, OTX2a, ..., and OTX6a and the third transmission signals OTX1b, OTX2b, ..., and OTX12b are alternately applied to the electrodes of the sensor layer 200 at a specific ratio (for example, 1:2), so that the input/output terminals of the input detection circuit 200C3 and the input/output terminals of the signal generation circuit 200C2 may be efficiently operated.

When the sensor driver 200C alternately applies the second transmission signals OTX1a, OTX2a, ..., and OTX6a and the third transmission signals OTX1b, OTX2b, ..., and OTX12b, the signals may be applied after being divided into a plurality of sub-frames similar to the method described with reference to FIGS. 18A to 22D.

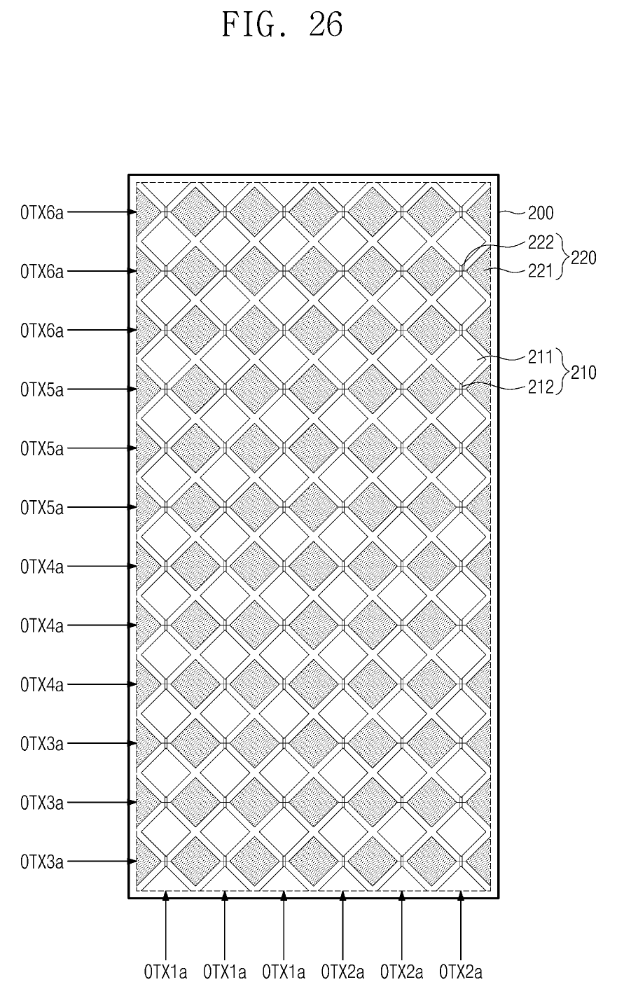

FIG. 25 is a diagram illustrating second transmission signals and third transmission signals in a sub-frame, according to an embodiment of the present disclosure.

Referring to FIG. 25, the second transmission signals OTX2a, OTX3a, OTX4a, and OTX5a and the third transmission signals OTX5b, OTX6b, OTX7b, and OTX8b corresponding to an area “A”, which is a portion of the sensor layer 200 may be applied during the first sub-frame SF1.

The area “A”, which is the portion of the sensor layer 200 may be an area determined to include the position of an object detected in a previous frame. The sensor driver 200C applies the second transmission signals OTX2a, OTX3a, OTX4a, and OTX5a and the third transmission signals OTX5b, OTX6b, OTX7b, and OTX8b only to the portion area “A” during one frame, and does not apply the transmission signals corresponding to the rest, thereby reducing the power consumption of the operation for detecting the position of the object.

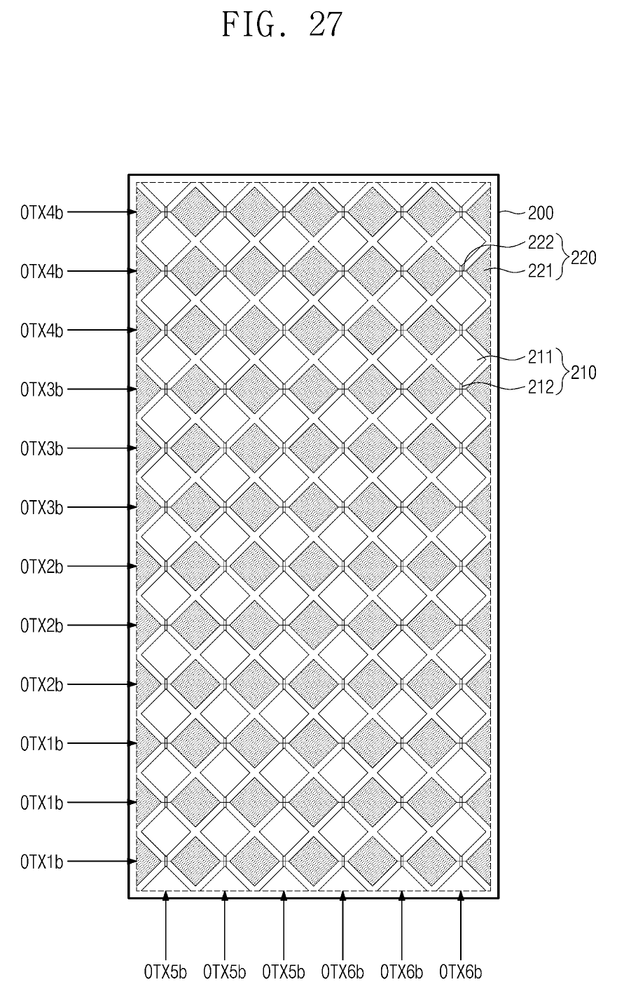

FIG. 26 is a diagram illustrating second transmission signals in a sub-frame, according to an embodiment of the present disclosure.

Referring to FIG. 26, during the first sub-frame SF1 of the second mode MD2, the same second transmission signals OTX1a, OTX2a, ..., OTX6a may be applied to some of the electrodes of the sensor layer 200.

During the first sub-frame SF1, the second transmission signal OTX1a may be applied to three consecutive electrodes among the first electrodes 210. The second transmission signal OTX2a may be applied to other three consecutive electrodes among the first electrodes 210.

During the first sub-frame SF1, the second transmission signal OTX3a may be applied to three consecutive electrodes among the second electrodes 220, and the second transmission signal OTX4a may be applied to other three consecutive electrodes among the second electrodes 220. The second transmission signal OTX5a may be applied to another three consecutive electrodes among the second electrodes 220, and the second transmission signal OTX6a may be applied to another three consecutive electrodes among the second electrodes 220.

Each of the second transmission signals OTX1a, OTX2a, ..., OTX6a may be applied to a plurality of electrodes. Through this, when the resolution for the position of the object is low, the position of the object may be determined with only a relatively small input/output of the signal generation circuit 200C2.

FIG. 27 is a diagram illustrating third transmission signals in a sub-frame, according to an embodiment of the present disclosure.

Referring to FIG. 27, during the first sub-frame SF1 of the second mode MD2, the same third transmission signals OTX1b, OTX2b, ..., OTX6b may be applied to some of the electrodes of the sensor layer 200.

During the first sub-frame SF1, the third transmission signal OTX1b may be applied to three consecutive electrodes among the second electrodes 220, and the third transmission signal OTX2b may be applied to other three consecutive electrodes among the second electrodes 220. The third transmission signal OTX3b may be applied to another three consecutive electrodes among the second electrodes 220, and the third transmission signal OTX4b may be applied to another three consecutive electrodes among the second electrodes 220.

During the first sub-frame SF1, the third transmission signal OTX5b may be applied to three consecutive electrodes among the first electrodes 210. The third transmission signal OTX6b may be applied to other three consecutive electrodes among the first electrodes 210.

Each of the third transmission signals OTX1b, OTX2b, ..., OTX6b may be applied to a plurality of electrodes. Through this, when the resolution for the position of the object is low, the position of the object may be determined with only a relatively small amount of input/output of the input detection circuit 200C3.

According to embodiments of the present disclosure, in the second mode, not only the signal generation circuit 200C2 but also the input detection circuit 200C3 may output a signal used to detect the position of the object. Through this, the number of signals that the object uses to detect the position during one sub-frame may be relatively greater. As the time for the signal to be output is reduced, the driving time for object detection may be shortened.

According to an embodiment of the present disclosure, the input detection circuit may receive detection signals from a sensor layer in a first mode and may output transmission signals used to determine the position of the object in a second mode.

Each of the signal generation circuit and the input detection circuit may provide a plurality of signals in one sub-frame by outputting transmission signals used to determine the position of the object to the sensor layer, and the driving speed may be improved.

Although the present disclosure has been described above with reference to embodiments thereof, it will be understood by those skilled in the art or having ordinary knowledge in the art that various modifications and substitutions are possible, without departing from the spirit and the technical scope of the present disclosure as set forth in the claims below.

Accordingly, the technical scope of the present disclosure is not limited to the detailed description of this specification, but should be determined by the claims.

What is claimed is:

1. An electronic device comprising:
a sensor layer including a plurality of electrodes;
a sensor driver configured to drive the sensor layer and to selectively operate in a first mode or a second mode different from the first mode; and
a main driver configured to control an operation of the sensor driver, and
wherein the sensor driver includes:
a signal generation circuit configured to output first transmission signals for detecting an input in the first mode to the sensor layer, and to output second transmission signals to the sensor layer in the second mode, the second transmission signals for use by an external object to determine a position relative to the sensor layer; and
an input detection circuit configured to receive detection signals corresponding to the first transmission signals from the sensor layer in the first mode, and to output third transmission signals to the sensor layer in the second mode, the third transmission signals for use by the external object to determine the position.

2. The electronic device of claim 1, wherein the input detection circuit includes:
a signal receiver configured to receive a detection signal of the detection signals from a corresponding electrode among second electrodes and to amplify and output the detection signal;
an analog-to-digital converter configured to convert an analog signal input from the signal receiver into a digital signal; and
a signal processor configured to sense the input based on the digital signal.

3. The electronic device of claim 2, wherein the signal receiver includes:
an operational amplifier having an inverting input terminal electrically connected to one of the second electrodes and a non-inverting input terminal for receiving a reference signal;
a capacitor connected in parallel to the inverting input terminal of the operational amplifier and an output terminal of the operational amplifier; and
a reset switch connected in parallel to both ends of the capacitor.

4. The electronic device of claim 3, wherein in the second mode, a negative feedback path is activated connecting the non-inverting input terminal of the operational amplifier and the output terminal of the operational amplifier, and
wherein in the second mode, one of the third transmission signals is input to the non-inverting input terminal of the operational amplifier.

5. The electronic device of claim 3, wherein in the second mode, a connection between an output of the signal receiver and the analog-to-digital converter is blocked.

6. The electronic device of claim 1, wherein the plurality of electrodes includes a plurality of first electrodes and a plurality of second electrodes intersecting with the plurality of first electrodes.

7. The electronic device of claim 6, wherein during a first sub-frame of the second mode, each of the second transmission signals is applied to a corresponding electrode among the plurality of first electrodes, and each of the third transmission signals is applied to a corresponding electrode among the plurality of second electrodes.

8. The electronic device of claim 6, wherein during a first sub-frame of the second mode, each of the second transmission signals is applied to a corresponding electrode among the plurality of first electrodes, and
wherein during a second sub-frame of the second mode, each of the third transmission signals is applied to a corresponding electrode among the plurality of second electrodes.

9. The electronic device of claim 6, wherein during a first sub-frame of the second mode, each of the second transmission signals is applied to a corresponding electrode among the plurality of first electrodes, and each of a first subset of the third transmission signals is applied to a corresponding electrode among the plurality of second electrodes, and
wherein during a second sub-frame of the second mode, each of the second transmission signals is applied to a corresponding electrode among the plurality of first electrodes, and each of a second subset of the third transmission signals is applied to a corresponding electrode among the plurality of second electrodes.

10. The electronic device of claim 6, wherein during a first sub-frame of the second mode, each of a first subset of the second transmission signals is applied to a corresponding electrode among the plurality of first electrodes, and each of the third transmission signals is applied to a corresponding electrode among the plurality of second electrodes, and
wherein during a second sub-frame of the second mode, each of a second subset of the second transmission signals is applied to a corresponding electrode among the plurality of first electrodes, and each of the third transmission signals is applied to the corresponding electrode among the plurality of second electrodes.

11. The electronic device of claim 6, wherein during a first sub-frame of the second mode, each of a first subset of the second transmission signals is applied to a corresponding electrode among the plurality of first electrodes, and each of a first subset of the third transmission signals is applied to the corresponding electrode among the plurality of second electrodes,
wherein during a second sub-frame of the second mode, each of a second subset of the second transmission signals is applied to a corresponding electrode among the plurality of first electrodes, and each of the first subset of the third transmission signals is applied to the corresponding electrode among the plurality of second electrodes,
wherein during a third sub-frame of the second mode, each of the first subset of the second transmission signals is applied to the corresponding electrode among the plurality of first electrodes, and each of a second subset of the third transmission signals is applied to a corresponding electrode among the plurality of second electrodes, and
wherein during a fourth sub-frame of the second mode, each of the second subset of the second transmission signals is applied to the corresponding electrode among the plurality of first electrodes, and each of the second subset of the third transmission signals is applied to the corresponding electrode among the plurality of second electrodes.

12. The electronic device of claim 11, wherein an area corresponding to the first sub-frame and an area corresponding to the second sub-frame share a first electrode of the plurality of first electrodes, and
wherein the area corresponding to the first sub-frame and an area corresponding to the third sub-frame share a second electrode of the plurality of first electrodes.

13. The electronic device of claim 6, wherein a first subset of the second transmission signals and a first subset of the third transmission signals are alternately applied to the plurality of first electrodes in a second direction, and
wherein a second subset of the second transmission signals and a second subset of the third transmission signals are alternately applied to the plurality of second electrodes in a first direction.

14. The electronic device of claim 6, wherein a first subset of the second transmission signals and a first subset of the third transmission signals are alternately applied to the plurality of first electrodes in a second direction based on a first preset ratio, and
wherein a second subset of the second transmission signals and a second subset of the third transmission signals are alternately applied to the plurality of second electrodes in a first direction based on a second preset ratio.

15. The electronic device of claim 6, wherein during a frame of the second mode, the second transmission signals and the third transmission signals corresponding to a subset of areas of the sensor layer are applied, and
wherein the subset of areas are determined based on the position of the external object determined in a previous frame.

16. The electronic device of claim 1, wherein each of the second transmission signals is applied to two or more corresponding electrodes.

17. The electronic device of claim 1, wherein each of the third transmission signals is applied to two or more corresponding electrodes.

18. An interface system comprising:
a display panel including a display layer which displays an image and a sensor layer which includes a plurality of electrodes;
a display driver configured to drive the display layer;
a sensor driver configured to drive the sensor layer and to selectively operate in a first mode or a second mode different from the first mode;
a main driver configured to control operations of the display driver and the sensor driver; and
an object configured to receive a signal from the sensor layer and to output an output signal including position information based on the signal to the main driver, and
wherein the sensor driver includes:
a signal generation circuit configured to output a first transmission signal for detecting an input in the first mode to the sensor layer; and
an input detection circuit configured to receive detection signals corresponding to the first transmission signals from the sensor layer in the first mode, and
wherein the sensor driver simultaneously or continuously outputs the second transmission signals and the third transmission signals to the sensor layer in the second mode, the second transmission signals and the third transmission signals for use by the object to determine a position relative to the sensor layer.

19. The interface system of claim 18, wherein the second transmission signals are output from the signal generation circuit, and the third transmission signals are output from the input detection circuit.

20. The interface system of claim 18, wherein the plurality of electrodes includes a plurality of first electrodes and a plurality of second electrodes intersecting with the plurality of first electrodes, and
wherein during a first sub-frame of the second mode, each of the second transmission signals is applied to a corresponding electrode among the plurality of first electrodes, and each of the third transmission signals is applied to a corresponding electrode among the plurality of second electrodes.
